(19) United States
(12) Patent Application Publication
(10) Pub. No.: US 2007/0203823 A1
(43) Pub. Date: Aug. 30, 2007

(54) SYSTEMS AND METHODS OF PROVIDING ONLINE LIVE AUCTIONS

(76) Inventors: Michael Whelchel, Indianapolis, IN (US); Oleksandr Lymar, Kiev (UA)

Correspondence Address: KNOBBE MARTENS OLSON & BEAR LLP, 2040 MAIN STREET, FOURTEENTH FLOOR, IRVINE, CA, 92614, US

(21) Appl. No.: 11/679,086

(22) Filed: Feb. 26, 2007

Related U.S. Application Data
(60) Provisional application No. 60/776,514, filed on Feb. 24, 2006.

(51) Int. Cl. G06Q 40/00

(52) U.S. Cl. 705/37

(57) ABSTRACT

A system and method of providing online live auction services is provided. In certain embodiments a client bidding module provide simultaneous access to multiple live auction events so that users can participate in several events taking place at the same time. Other embodiments include methods for estimating the time at which a particular lot is likely to be brought to the auction floor for bidding. Other embodiments include a web-based bidding module that provides access to a live auction and provides near real-time updates without needing to refresh the browser web page.

### CROSS-REFERENCE TO RELATED APPLICATIONS

This application claims the benefit of U.S. Provisional Patent Application No. 60/776,514, filed on Feb. 24, 2006, the disclosure of which is incorporated by reference herein in its entirety. This application is related to U.S. patent application Ser. Nos. ______, ______, and ______, each entitled “SYSTEMS AND METHODS OF PROVIDING ONLINE LIVE AUCTIONS” (Attorney Docket Nos. AFINC.001A2, AFINC.001A3, and AFINC.001A4, respectively), filed on this day, each of which is incorporated by reference in its entirety.

### BACKGROUND OF THE INVENTION

1. Field of the Invention

This application relates to online auctions. More particularly, this application relates to systems and methods for efficiently providing live auctions across multiple auction platforms so that bidders may effectively participate in multiple simultaneous online auctions and auctioneers may effectively maintain multiple simultaneous live online auctions.

2. Description of the Related Technology

Traditionally, live auctions have been conducted in specific locations such as auction houses. The traditional live auctions are attended by bidders (or their agents/proxies) who submit bids to the auctioneer via defined gestures or vocal signals. The auctioneer typically accepts bids until no more bids are offered, and at that time typically awards the auctioned item or items (also known as lots) to the highest bidder. As used herein, the terms “lot” and “item” are used interchangeable as they relate to things offered for auction.

As the use of the Internet to conduct business transactions became more prevalent, Internet auctions offered by websites such as eBay.com® became popular among the general public. Most of these Internet-based auctions are of the “timed” variety. A timed auction is an auction which includes a bidding process which ends at a specific pre-determined time. In a typical timed auction, participants are allowed to view the bid progression has the time period associated with the item nears expiration. This protocol contrasts with a “secret” auction in which the value of bids received on items are not disclosed prior the close of the auction on the particular item. Although timed auctions may be active for several days, bidders tend to focus on the last few hours or even minutes of a timed auction so that they have a better sense of the likely value of a winning bid. Because the timed auction is set to end at a time certain, prospective bidders often adjust their schedule to revisit the auction for that item of interest at or near the time the auction is set to expire. Thus, the timed auction model allows bidders to place bids on an items without a significant time commitment. Moreover, because the timed auctions are available for days at a time, a bidder may submit a bid on an item well in advance of the auction deadline, and then set some time aside to revisit the auction event just prior to the time the bidding period ends in order to submit additional bids if necessary or desired. Thus, the timed auction model allows bidders to avoid actively participating during the entire auction period and still be a successful bidder.

As live auctions have been transitioned to the Internet, the benefit and convenience provided by timed auctions has not been generally made available to online live auction bidders. This lack of convenience results from the fact that live auctions typically include hundreds or thousands of items which are offered consecutively for bidding. Thus, a bidder may be interested in only a single lot of the auction event, but that lot may positioned so that hundreds of lots are auctioned before it. Unlike in timed auctions, live auctions usually do not place a time constraint on how long an item will be offered for bidding. Usually, the bidding ends when no additional offers are forthcoming. As a result, the length of time associated with each item in an auction event tends to vary, and a prospective bidder must often wait for the auction of many items before their item of interest goes live because they have no certainty of when their item of interest will come to the auction floor for live bidding.

Many bidders are not willing to commit the time necessary to effectively participate in live auctions, and as a result, live auctions tend not to receive as many bids from Internet-based bidders as might otherwise be possible if the issues of timing and convenience could be resolved. Thus, it would be an advancement and an improvement in the art to provide systems and methods which address these and other shortcomings.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In one embodiment a system for providing concurrent access to a plurality of live auctions on a communications network is provided. The system includes a multi-platform live auction system configured to provide live auction services to a plurality of concurrent live auction events, the mutil-platform live auction system comprising an application server configured to connect to a database storing information related to the plurality of live auction events. The system also has a client bidding module configured to concurrently connect the plurality of live auction events by establishing a network connection with the application server in order to request updated data from the database. The client bidding module is further configured to receive a selection of one or more items from a first live auction event and the one or more items from a second auction event as a saved lot grouping and the application server is further configured to save the received selection in the database. Upon a request from the client bidding module for the saved lot grouping, the application server is configured to automatically load the first and second auction events into the client bidding module.

In another embodiment, a computer-implemented method of providing concurrent access to a plurality of live auctions is provided. The method includes loading a first live auction ring into a memory of a client bidding module and loading a second live auction ring into the memory. The method further includes concurrently displaying an auction of a first lot in the first live auction ring and an auction of a second lot in the second live auction ring.

In yet another embodiment, a computer-implemented method of providing simultaneous access to a plurality of live auctions over a communications network is provided. The method includes receiving a request from a potential bidder to establish a connection and granting the request to establish the connection. A request is received from the client device for a first live auction ring and the first live auction ring is added to the list of requested rings. The method further include receiving a request for a second live auction ring and adding the second live auction ring to the list of requested rings. The first auction ring and the second auction ring are sent to the potential bidder.

In still another embodiment, a computer-readable medium is provided which comprises computer-executable instructions which when executed cause a computing device to perform a method of providing concurrent access to a plurality of live auctions over a communications network. The method includes The method includes receiving a request from a potential bidder to establish a connection and granting the request to establish the connection. A request is received from the client device for a first live auction ring and the first live auction ring is added to the list of requested rings. The method further include receiving a request for a second live auction ring and adding the second live auction ring to the list of requested rings. The first auction ring and the second auction ring are sent to the potential bidder.

In still another embodiment, a system for providing concurrent access to a plurality of live auctions on a communications network is provided. The system has means for providing live auction services to a plurality of concurrent live auction events, the means for providing live auction services comprising means for connecting to a means for storing information related to the plurality of live auction events, and means for concurrently connecting to the plurality of live auction events by establishing a network connection with the means for connecting in order to request updated data from the means for storing information. The system further includes means for receiving a selection of one or more items from a first live auction event and the one or more items from a second auction event as a saved lot grouping. Upon a request for the saved lot grouping, the means for connecting to the means for storing information automatically loads the first and second auction events.

### BRIEF DESCRIPTION OF THE DRAWINGS

In this description, reference is made to the drawings wherein like parts are designated with like numerals throughout.

FIG. 1 is a block diagram of an existing online live auction implementation.

FIG. 2 is a block diagram of a network environment suitable for practicing various aspects of one embodiment.

FIG. 3 is a more detailed view of the multi-platform live auction system from FIG. 2.

FIG. 4 is a more detailed view of the external platform interface of FIG. 3.

FIG. 5 is a block diagram showing the participants in a live auction.

FIG. 6 is an example of an auction operator interface client which is used to receive and update bids during a live auction.

FIG. 7 is a flowchart illustrating the general process for an online live auction.

FIG. 8 is a flowchart illustrating a process by which bids received and accepted from various sources during online auctions.

FIG. 9 is a flowchart of a process by which bids received in the MPLAS are distributed to other platforms.

FIG. 10 is a flowchart of a process by which bids received by an external platform are distributed to the MPLAS.

FIG. 11 is block diagram illustrating a system supporting multiple simultaneous live auction rings.

FIG. 12 is an example of a user interface which allows a bidder to simultaneously access and bid within multiple auction rings.

FIG. 13 is a flowchart showing a process by which a user can filter and save lots for bidding.

FIG. 14 is a flowchart of a method of providing a bidder with access to multiple simultaneous rings.

FIG. 15 is a flowchart demonstrating a method by which a user can target specific lots in multiple auction rings.

FIG. 16 is a more detailed block diagram web bidding module from FIG. 3.

FIG. 17 is an example of a user interface for the web bidding module.

FIG. 18 is another example of a user interface for the web bidding module.

FIG. 19 is an example of how the web bidding module can be configured to allow a user to bid on one item while viewing another item.

FIG. 20 is a flowchart illustrating a process by which live auction events are provided by in a web interface.

FIG. 21 is a flowchart of a process by which left bids are placed and provided as live bids during a live auction.

FIG. 22 is an example of a user interface that displays live auction information and can be used to submit left bids.

FIG. 23 is another example of a user interface that displays live auction information and can be used to submit left bids.

FIG. 24 is an example of a user interface that displays information of multiple live auctions and can be used to submit left bids.

FIG. 25 is an example of a user interface that is displayed at the auction house and used to provide left bids as live bids during a live auction.

FIG. 26 is a flowchart of a process that provides time estimates of when a lot is going to be auctioned.

FIG. 27 is an example of a user interface connected to the MPLAS that displays time estimate information.

FIG. 28 is another example of a web based user interface connected to the MPLAS that displays time estimate information.

FIG. 29 is an example of a user interface connected to an external live auction platform that displays time estimate information.

FIG. 30 is an example of a user interface that displays time estimates for each left bid or saved lot.

FIG. 31 is an example of a bidder client module user interface connected to the MPLAS that displays time estimates for numerous items or lots.

FIG. 32 is an example of a user interface that is used to enter a time estimate for running the live auction.

### DETAILED DESCRIPTION OF CERTAIN INVENTIVE EMBODIMENTS

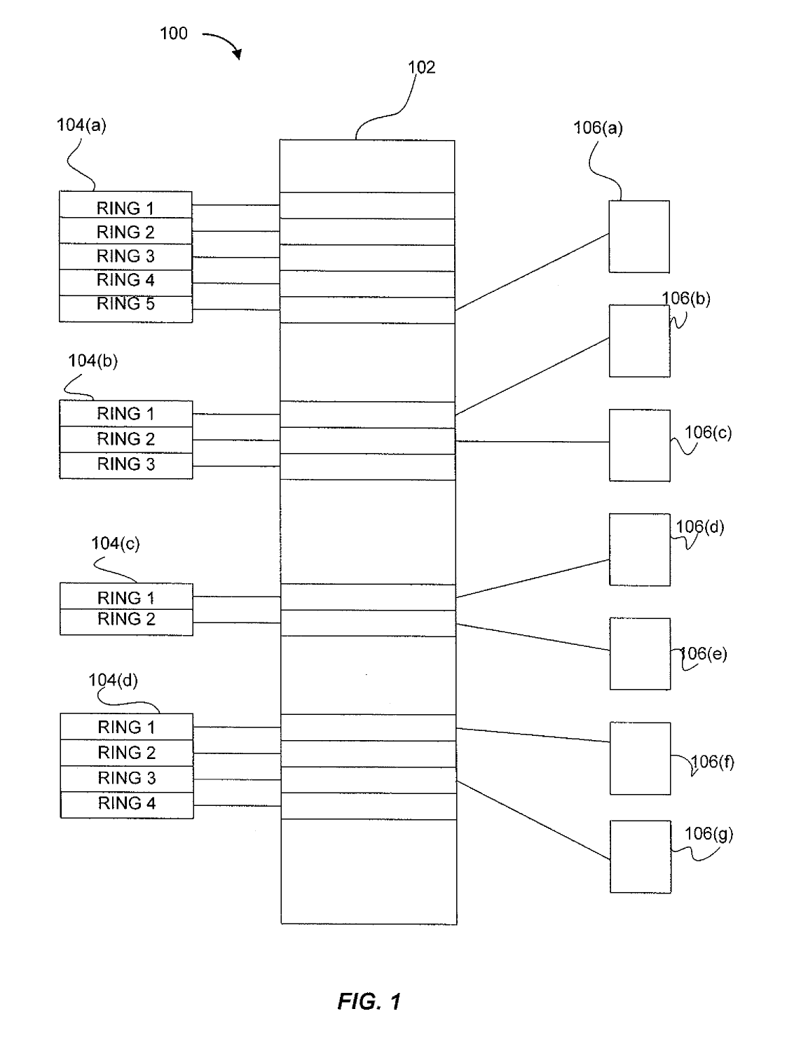

The following detailed description is directed to certain specific embodiments of the invention. However, the invention can be embodied in a multitude of different ways as defined and covered by the claims. In this description, reference is made to the drawings wherein like parts are designated with like numerals throughout. Various embodiments provide systems and methods for creating, implementing, managing, and participating in live auctions over a communications network. One problem associated with existing live auction systems is their inability to allow bidders to participate in multiple simultaneous live auctions. FIG. 1 is an example of an existing network-enabled live auction system 100. The system 100 includes a live auction platform 102 which allows multiple auction houses 104(a)-104(d) to offer their live auctions over the Internet.

As is often the case with live auction events, a single auction house may offer more than one live auction session during a live auction event. For example, an auction house may have a first auction session offering baseball-related items, a second auction offering antique furniture, and a third auction offering items from an estate sale. Each of these sessions may be referred to as a “ring.” In the example provided in FIG. 1, the auction event 104(a) has five rings, auction event 104(b) has three rings, auction event 104(c) has two rings, and auction event 104(d) has four rings. Each ring is connected to the live auction platform 102 and made accessible to bidders 106 over a communications network. The live auction platform 102 may support many simultaneous auction events 104 and their associated rings. However, each bidder 106 is able to connect to only a single ring at a time. For example, bidder 106(a) connects only to Ring 5 of auction event 104(a). Similarly, bidder 106(b) connects only to Ring 1 of auction event 104(b). As a result, each bidder 106 is able to participate only in a single ring at a time, and if a bidder 106 is interested in items available in different rings and auction events, the bidder cannot participate in both auctions simultaneously.

Certain embodiments of the invention provide systems and method which allow bidders to participate simultaneously in multiple live auctions. Similarly, various additional embodiments allow for auction houses and other persons offering live auctions to simultaneously offer live auctions across multiple live auction platforms. By providing an auction management platform with these features, auction houses are able to reach larger bidding audiences and increase the number of active bidders for their live auctions.

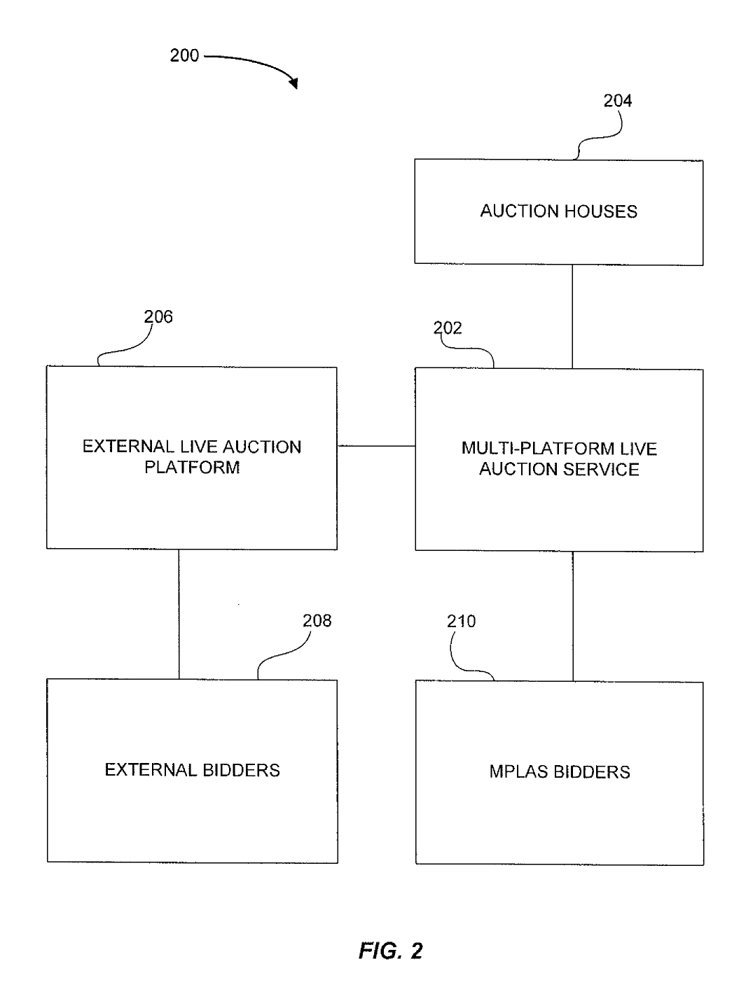

Referring now to FIG. 2, a block diagram of a network environment 200 suitable for the implementation of various aspects of the invention is provided. In some embodiments, the network environment 200 may take the form of a wide area network such as the Internet. Communication among network devices may occur over defined network connections made using a network protocol such as TCP/IP. Although the embodiments described herein are implemented within the context of a TCP/IP wide area network, one of skill in the art will readily appreciate that the network environment 200 may include any of a number of different types of networks including local area networks, wireless networks, or some other types of network.

The network environment 200 includes a multi-platform live auction service (MPLAS) 202. As will be discussed in further detail below, the MPLAS 202 provides a live auction service which may be distributed across one or more external live auction platforms 206 via a network connection. Auction houses 204 access the MPLAS 202 to create and manage their live auctions, and to make the live auctions available on external live auction platforms 206 so that they may be accessible to external bidders 208. Directly accessing the MPLAS 202 are MPLAS bidders 210. The MPLAS bidders 210 access the MPLAS 202 via one or more client software interfaces which will be described in additional detail below.

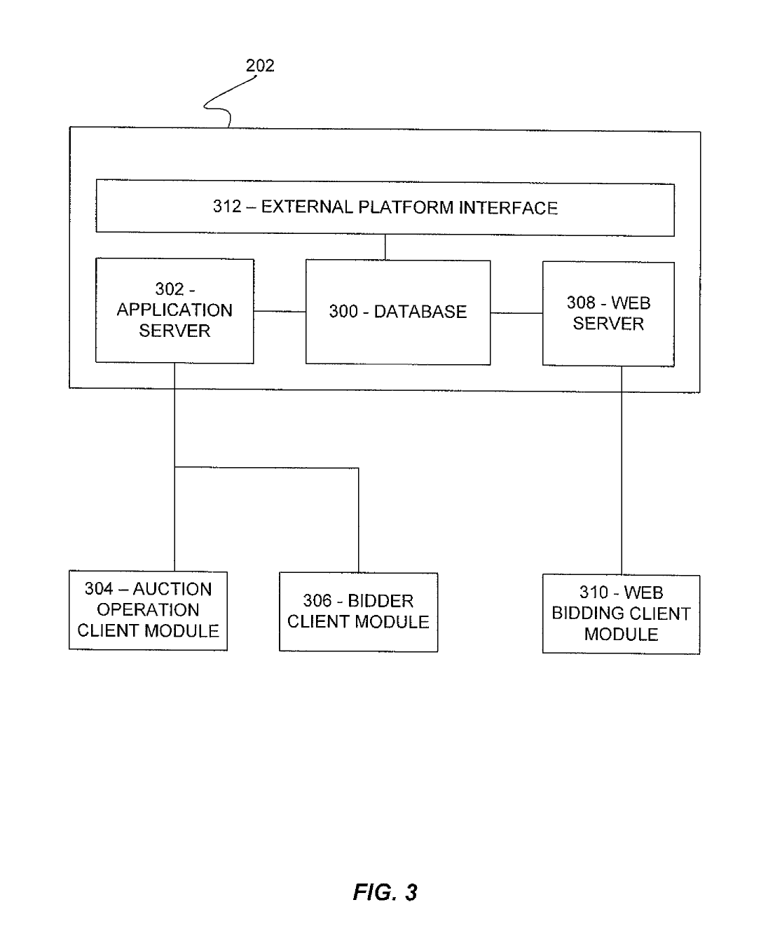

FIG. 3 provides a more detailed view of the MPLAS 202 shown in FIG. 2. The MPLAS 202 may take various forms. In one embodiment, the MPLAS is a web service that is implemented across one or more servers in electric communication via network connections or some other type of connection direct or point-to-point connection. The servers may be running a general commercial operating systems such as Windows Server, Linux, Unix, or some other off-the-shelf operating system. Alternatively, the customized operating systems may be utilized.

The MPLAS 202 may include various logical subcomponents which are configured to provide functionality and interaction with the network environment 200. The MPLAS typically includes a database 300 which stores data related to each of the online live auctions managed by the MPLAS 202. The database 300 may be a database provided by relational database management software such as SQL Server, Oracle, or MySQL. In alternate embodiments, the database 300 may be an object-oriented database or an object relational database. The data stored in the database 300 may include user information for MPLAS bidders 210 and auction houses 204. The user information may be used to permit selective access to the MPLAS 202. The database 300 may further store information related to live auctions managed by the MPLAS 202. This data may include information such as the time and location a live auction event, information about the rings and lots offered in the live auction event, and bidding information related to the lots.

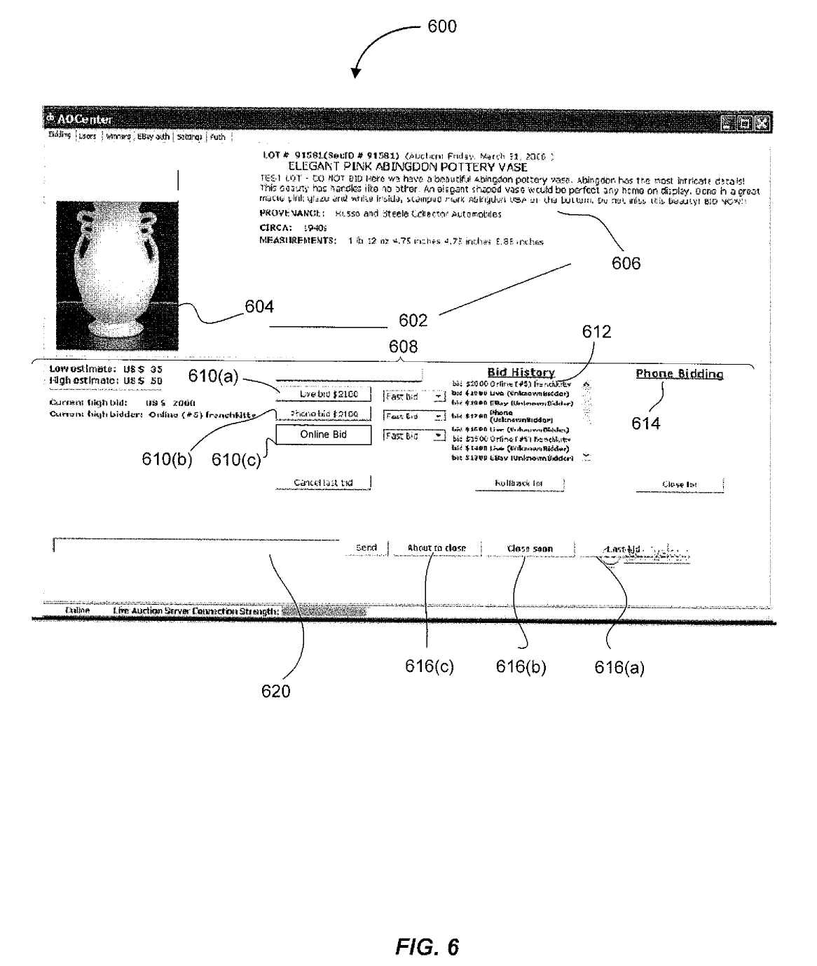

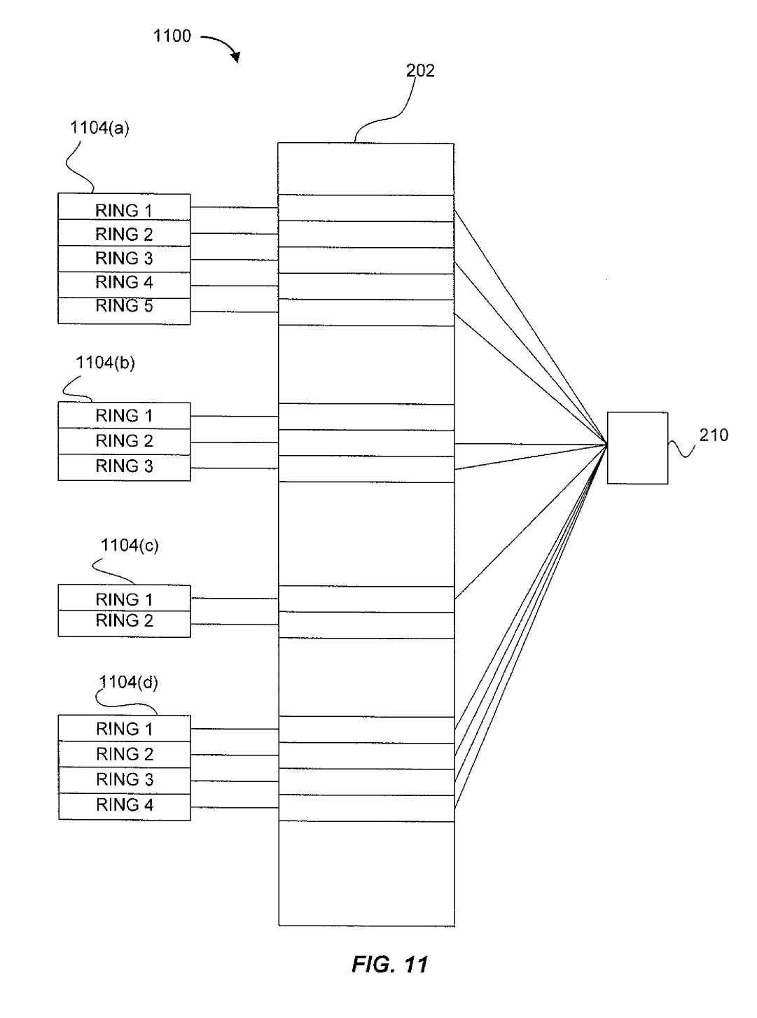

The database 300 may be configured to receive requests from an application server 302. The application server 302 may be a well-known commercial application server such as a Java-based application server such as a WebLogic Server, a JBoss server, a WebSphere server, or some other type of application server. The application server 302 provides application services to client applications such as auction operation client module 304 and bidder client module 306. The auction operation client module 304 may take the form of a software application running on a computing device which is configured to allow an auction house to manage and implement their live auctions via the MPLAS 202. The auction operation client module 304 will be discussed in further detail below in connection with FIG. 6. The bidder client module 306 may also take the form of a software application running on a computing device which may used by bidders 210 registered to use the MPLAS 202 to submit bids. In some embodiments, the bidder client module 306 allows users to participate in multiple live auctions simultaneously as will be described below in connection with FIGS. 11-15.

Also connecting to the database 300 is a web server 308. The web server 308 may be a well-known web server such as an Apache web server, an Internet Information Server offered by Microsoftg, or some other type of web server that provides HTTP service to a web browser. Although shown in the figure as directly accessing the database 300, a skilled artisan will readily appreciate that the web server 308 may communicate with the database via some form of middleware or via the application server 302.

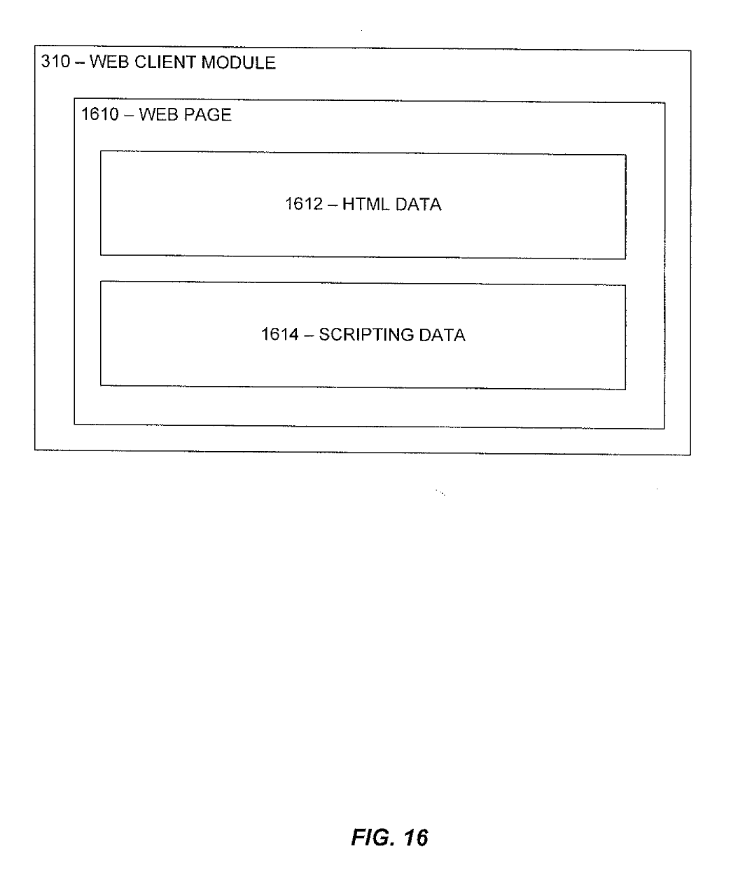

Connecting to the web server 308 may be one or more web bidding client modules 310. The web-based bidding client 310, which will be described in further detail below in connection with FIGS. 16-20, allows bidders 210 to access the MPLAS 202 through a dynamic web interface which receives timely updates and allows the bidders 210 to effectively participate in live auctions without the need for specialized software on their computing devices. Each of the auction operation client module 304, the bidder client software module 306 and the web-based bidding client 310 may be configured to run on various types of computing devices including desktop personal computers, notebook computers, handheld devices, cell phones, tablet computers, or some other computing devices.

Also connecting to the database 300 is an external platform interface 312. The external platform interface 312 provides an interface to external live auction platforms 206 via an external network connection 314. The external platform interface 312 allows auction houses 204 utilizing the MPLAS 202 to distribute their live auctions to external live auction platforms 206 (using a single management interface) in such a way that they are accessible to external bidders 208 who may not be registered to use the MPLAS 202. The external platform interface 312 may take various forms. In one embodiment, the interface is a software module running on the database server along with database 300. Alternatively, the external platform interface 312 may be one or more dedicated servers which are configured to access external live auction platforms as will be discussed in further detail below. In still other embodiments, the external platform interface 312 may be a software module which is implemented as part of the application server 302.

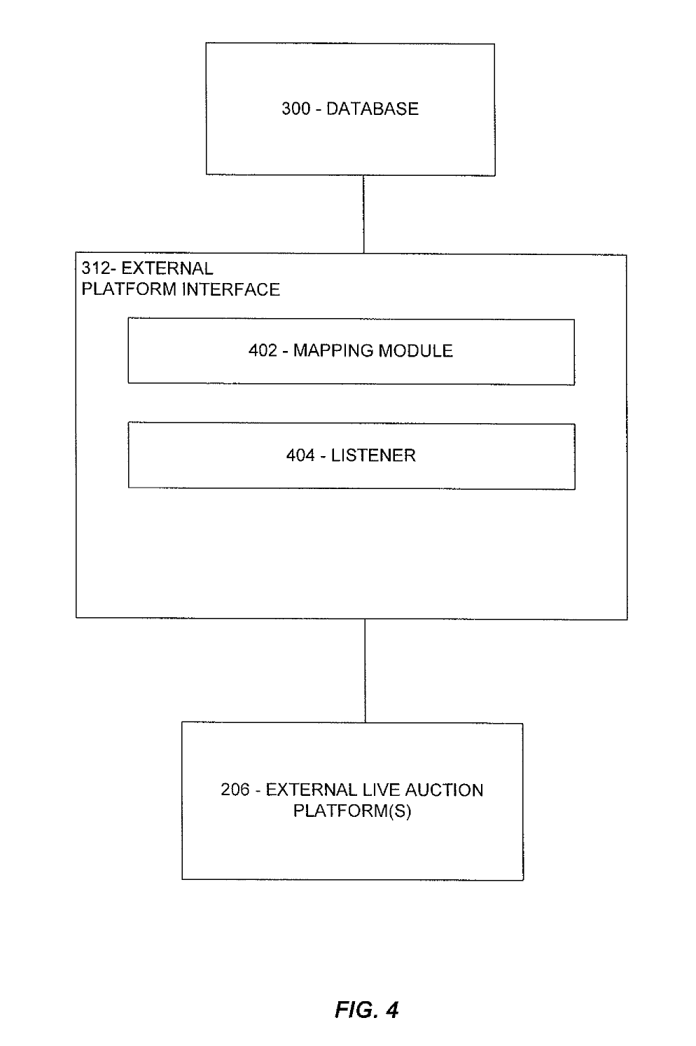

Referring now to FIG. 4, a more detailed view of the external platform interface 312 is provided. The external platform interface 312 may include one or more listeners 404. The listeners 404 are typically configured to check for or receive changes in data stored in either the database 300 or in the external live auction platforms 206. The listener 404 is configured to help keep the data related to a live auction event synchronized among the various platforms supporting that online live auction event. In some embodiments, the listener 404 may be configured to send requests for updates to each of the external live auction platform 206 and the database 300 at a periodic interval. Changes detected by the listener 404 in the external live auction platform 206 or the database 300 may be then passed to the mapping module 402. The mapping module 402 is then used to convert data from a format used by one system into a format used by another system.

By way of example and not of limitation, the listener 404 may receive a bid submitted by an external bidder 208 on the external live auction platform 206. The bid data received from the external live auction platform 206 may be in a format that is specific to the external live auction platform 206. The mapping module 402 is configured to receive the data from the external live auction platform format and repackage it into a format which is usable by the database 300 on the MPLAS 202. Once the data has been repackaged, it may then be used to update the database 300. Similarly, updates to the database 300 may be received by the listener 404 and passed to the mapping module 402. The mapping module 402 may then convert the received data to a format usable by the external live auction platform 206 so that the appropriate data can be updated and then distributed to clients accessing the external platform system 206.

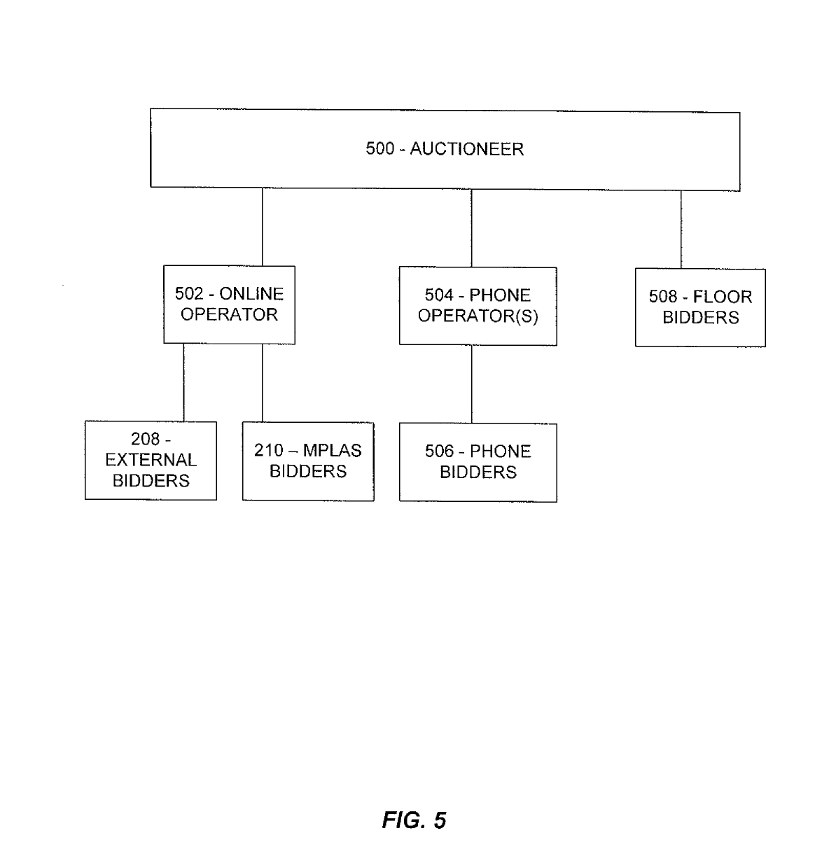

As noted above, a live online auction event is typically conducted as a hybrid online/live auction event. Thus, the live auction takes place on a physical auction floor with floor bidders participating from the physical location of the auction event, while telephone bidders and online bidders participate via a remote connection. FIG. 5 is a block diagram showing the various participants in a live auction event managed by the MPLAS 202 according to some embodiments described herein.

The live auction event is typically controlled by an auctioneer 500. An auctioneer 500 presides over the auction event. In a live auction event, the auctioneer 500 typically can receive bids from at least four sources: external bidders 208, MPLAS bidders 210, telephone bidders 506 and floor bidders 508. Floor bidders 508 are persons in the same physical location as the auctioneer 500. Floor bidders 508 typically submit a bid to the auctioneer 500 by making a specific gesture or sound. The auctioneer 500 may choose to accept the bid from the floor bidder 508, or the auctioneer may choose to accept a bid from another bidding source.

Phone bidders 506 may also participate in the online live auction event. In one embodiment, phone bidders 506 are in communication with one or more phone operators 504 who relay bids from the phone bidders 506 to the auctioneer 500 in real time. Thus, when a phone bidder 506 wishes to bid on a lot, the phone bidder 506 indicates to the phone operator 504 that they wish to place a bid. The phone operator 504 may make a gesture or other indication that a phone bid is being offered. As with the bids offered by floor bidders, the auctioneer 500 may choose to accept or not accept the bids received from the phone bidders 506. In addition, as new bids are accepted by the auctioneer 500, the phone operator 504 may relay the new bid amount to the phone bidders 506 (or alternatively, the phone bidders may be directly patched into an audio feed of the event.

As noted above, an auctioneer 500 conducting a live auction event managed by the MPLAS 202 may also receive bids from online bidders. The online bidders may include MPLAS bidders 210 who submit bids via the bidder client module 306 or the web-based bidding client module 310. The online bidders may further include external bidders 208 who submit bids to the external live auction platform 206 which in turn sends the bid to the external platform interface 312 where the bid is mapped to the MPLAS 202 and sent to the an online operator 502. The online operator 502 may be access the MPLAS 202 via the auction operation client module 304, and the received online bids may be displayed in the graphical user interface of the auction operation client module 304 as will be described in further detail below in connection with FIG. 6.

Upon receiving an online bid, online operator 502 typically alerts the auctioneer 500 of any bids submitted from the online bidders. Upon receiving a submitted bid from an online bidder, the online operator 502 may provide a signal to the auctioneer 500 that an online bid has been received. The signal may be a physical gesture or sound, or it may take the form of a notification signal (such as an illuminated light on the auctioneer's console 500, for example) indicating to the auctioneer 500 that an online bid has been received.

In addition to receiving and managing online bids, the online operator 502 may perform additional functions related to the live online auction event. For example, the online operator 502 may use the auction operation client module 304 to update the status of the bidding in the live auction so that the updates are entered into the database 300 via the application server 302, and then distributed to the appropriate bidding clients.

Referring now to FIG. 6, an example of a bidding management user interface 600 for the auction operation client module 304 is provided. The bidding management user interface is used by the online operator 502 to receive online bids and send bidding updates to the application server 302 based on the actions of the auctioneer 500. Although a particular configuration of the bidding management interface 600 is shown in FIG. 6, a skilled artisan will readily appreciate that the configuration shown is but one of many suitable user interface configurations for implementing the functionality of the MPLAS system 202.

The bidding management interface 600 includes a lot information interface element 602 which displays information about the current lot to the online operator 502. The lot description element 602 may include various sub-elements which provide specific information about the current lot in the live auction event. For example an item display area 604 may include a photograph or some other graphic image related to the lot up for auction. The lot description element 602 may further include lot description text 606 which provides a more detailed description of the lot up for auction. The data displayed in these portions of the interface 600 may be retrieved from the database 300 via the application server 302 pursuant to a data request from the auction operation client module 304.

The bidding management interface 600 may also include a live bidding area 608 which provides user interface elements which allow the online operator 502 to effectively manage the online live auction event. As noted above, the auctioneer 500 is responsible for accepting bids during the live auction. At any given price point, there may be many bids submitted to the auctioneer. However, the auctioneer 500 typically accepts only a single bid at a time. Accepting a submitted bid results in an increase in the current high bid, and the remaining bids submitted at the current high bid amount are disregarded or ignored.

The live bidding area 608 is configured to allow the online operator 502 to react to the actions of the auctioneer 500 and provide updates to the MPLAS 202 accordingly. The live bidding area 608 includes bid acceptance buttons 610. When a bid is accepted by the auctioneer 500, the online operator 502 actuates one of the bid acceptance buttons 610 indicative of the source of the accepted bid. The current high bid 612 and current high bidder 614 are then updated by the auction operation client module 304 accordingly.

In the example provided in FIG. 6, three are three bid acceptance buttons. The first bid acceptance button 610(a) sends a message to the MPLAS 202 that a live bid has been accepted from a floor bidder 508. The second bid acceptance button 610(b) sends a message to the MPLAS 202 that a bid from a phone bidder 506 has been accepted. The third bid acceptance button 610(c) sends a message to the MPLAS 202 that a bid has been accepted by the auctioneer 500 that originated from an online bidder such as external bidder 208 or MPLAS bidder 210.

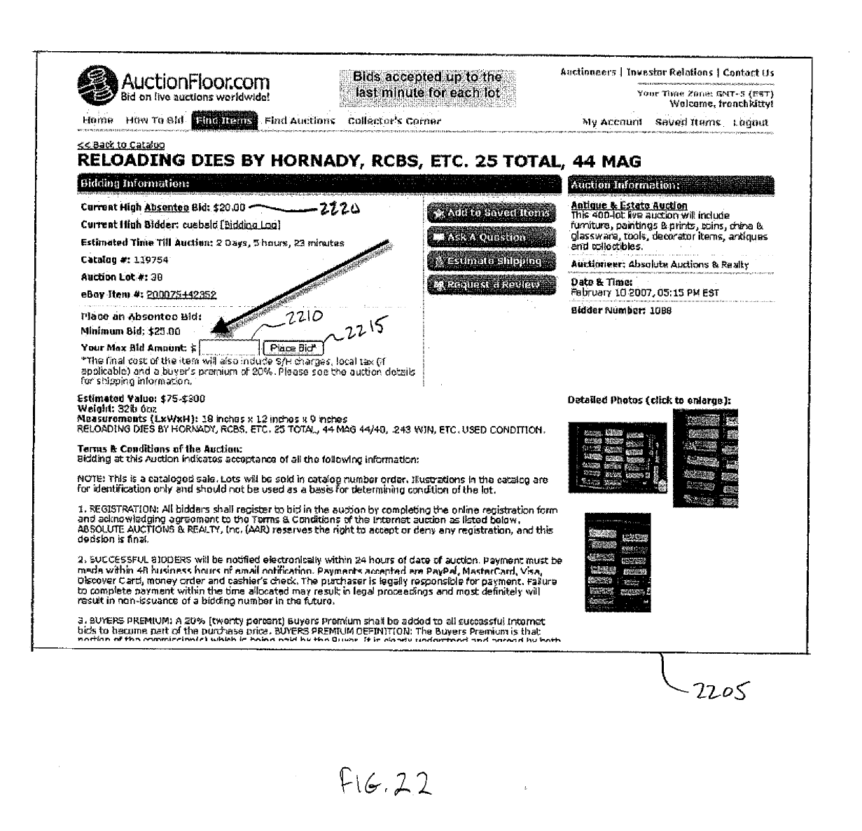

The live bidding area 608 also includes a bid history window 612 which displays the bidding history for the current lot. The information in the bid history window 612 is updated each time a new bid is accepted by the auctioneer 500 and the online operator 502 selects a corresponding bid acceptance button 610. The bid history displayed in the bid history window 612 may include the bid amount, the location of the bidder (e.g., floor, phone, online), and the identity of the bidder (if known). The bidding area 608 may also include a phone bidding window 614. In some embodiments, bidders accessing an online catalog (discussed below in connection with FIG. 22) can select a “leave phone bid” option. Selection of the “leave phone bid” option results in the phone number of the bidder appearing in phone bidding window 614, indicating that an online view wishes to place bid by telephone. This indication typically appears prior during the bidding for lots preceding the requested item. The online operator 502 or the phone operator 504 may then call the bidder at the phone number appearing the phone bidding window 614 in order to receive the phone bid.

In some embodiments, the bid acceptance buttons 610 may be dynamic buttons. For example, in the example provided in FIG. 6, the buttons include the bid amount ($2100) that will be accepted when then button 610 is actuated by the online operator 502. In other embodiments, the buttons may be inactive if there is no bid received from the button source. For instance, if no online bid has been received at the current bidding level, the online bid button 610(c) may be inactive and unavailable for selection. When a bid arrives from the MPLAS, the online bid button 610(c) may activate and if the auctioneer 500 accepts the online bid, the online operator 502 then may actuate the online bid button 610(c) to indicate acceptance of the online bid. Similarly, if no phone bid has been received at the current bidding level, the phone bid button 610(b) may be inactive and unavailable for selection.

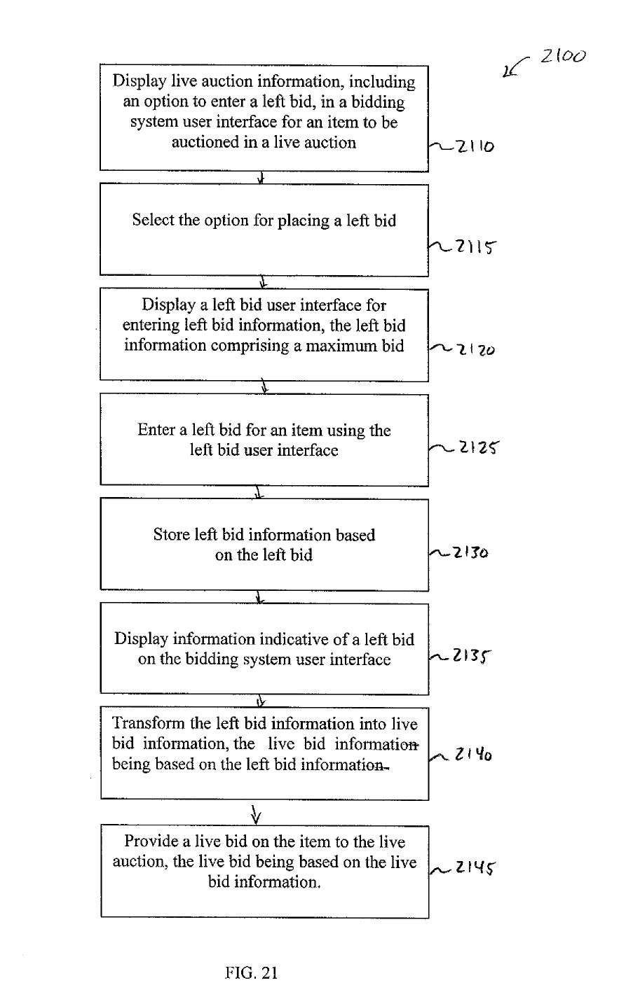

Embodiments of the present invention present bidders who do not attend a live auction with improved bidding options, including the ability to bid using “left bids.” Left or absentee bids are bids that a bidder leaves (submits) on a lot prior to the live auction. Normally when left bids are accepted before the auction they are manually handed to a live clerk and that clerk presents the bids when the auctioneer reaches the lots having left bids. Embodiments discussed hereinbelow (e.g., in reference to FIGS. 21-25) integrate left bids into the bidding platform which can present the left bids in real time when the items comes up for auction live, obviating the live clerk's task of sorting and organizing the left bids hours before the live auction begins. This new left bid process is advantageous to because it offers bidders the option of submitting a left bid (e.g., via the MPLAS 202) only moments before a particular lot comes up for auction, rather than before the entire auction begins. Left bids appear as an online bid submitted from the MPLAS 202.

As an auction for a particular lot moves to closing, the online operator 502 may utilize the auction status buttons 616 located toward the lower portion of the display 600. The auction status buttons include buttons that send status updates regarding the current lot to the MPLAS 202. When a high bid is received and no additional bids appear to be forthcoming, the online operator may select one or more of the auction status buttons 616 to indicate that the auction of the current lot will close soon if no higher bids are received. In the example provided in FIG. 6, the last bid button 616(a) indicates that auction is beginning to close. The close soon button 616(b) sends a message to the MPLAS 202 that the auction is proceeding to close because new higher bids have not been received. The about to close button 616(c) sends a message that the auction of the current lot is about to close. The MPLAS 202 takes these messages received from the auction operation client module 304 and distributes them to the online bidders 208 and 210 participating in the auction event. In addition, the interface 600 may further include a custom message element 620 which allows for the online operator 502 to type specific messages and send them to online bidders.

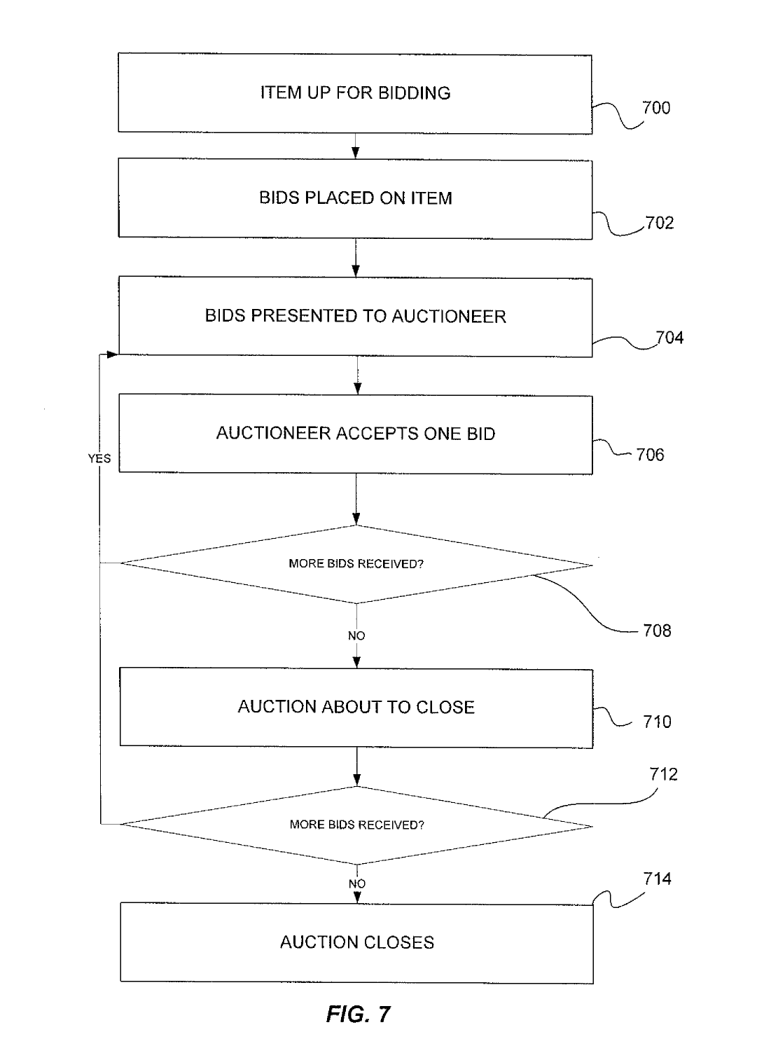

Referring now to FIG. 7, an example of the general process for a live online auction of an item or lot is provided. The process begins at block 700, where an item or lot comes up for bidding. Next, at block 702, one or more bids are received on the item. As noted above, the bids may arrive from various sources, including floor bidders 508, phone bidders 506, MPLAS bidders 210 and external platform bidders 208. The process then moves to block 704, where the bids are presented to the auctioneer 500. Sometimes, multiple bids may be received from a single source. For example, three bids from floor bidders 510 may be submitted to the auctioneer 500, and two bids from phone bidders 506, and five bids may be received via the MPLAS 202. In some embodiments, the MPLAS 202 filters the received online bids to present only the first received bid to the auctioneer 500 via the auction operation client module 304. At block 706, the auctioneer 500 accepts one of the submitted bids. Typically, the first received bid at the highest price will be selected by the auctioneer, although the auctioneer 500 may exercise considerable discretion in accepting bids.

The process then moves to block 708 where the auctioneer 500 waits to see if additional bids are received from the floor bidders 508, the phone bidders 506, or the online bidders 208 and 210. If a new bid is received, the process returns to block 704, where the received bid(s) is presented to the auctioneer 500. If, at decision block 708, no new bids are received that are higher in price than the current bid, the process moves to block 710, where the auctioneer indicates that the auction will close soon. The online operator 502 may at that time select the corresponding auction status buttons 616 so that the status is sent the online bidders 208 and 210 via the MPLAS 202. Next, the process moves to decision block 712 where the auctioneer 500 waits for additional bids. If a bid is received before the auctioneer 500 closes the auction, the process returns to block 704 as described above. Otherwise, the process moves to block 714 and the auction for the current lot closes, and the lot is awarded to the highest bidder.

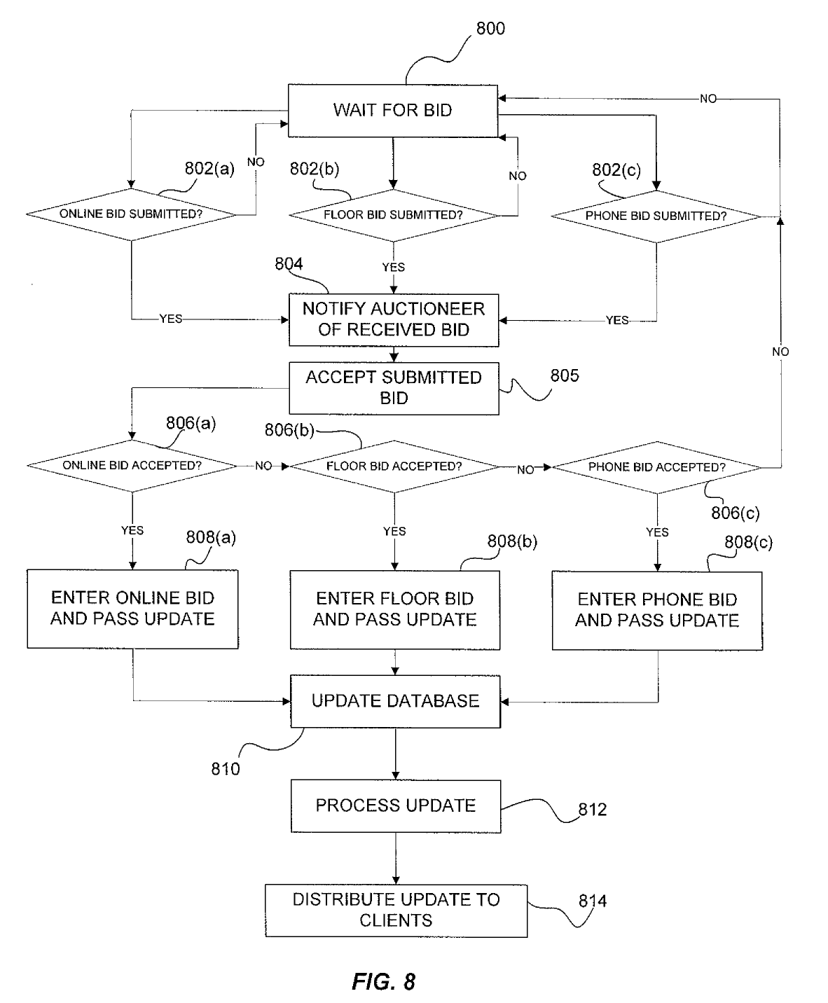

As the auction process described in FIG. 7 takes place during a live auction event, the MPLAS 202 is configured to maintain the database 300 to reflect the status of the live auction event, and provide online bidders 208 and 210 with current data which enables the online bidders to effectively and timely submit bids if desired. FIG. 8 is a flowchart of a process by which the MPLAS 202 and the auction operation client module 304 may be used to manage the live auction event.

The process begins at block 800, where the auctioneer 500 waits for bids on the current lot. The process then moves to decision blocks 802(a), 802(b), and 802(c). With respect to block 802(a), if an online bid has been submitted via the MPLAS 202, the process moves to block 804, where the auctioneer 500 is notified of the submitted online bid as described above in connection with FIGS. 6 and 7. Similarly, at block 802(b) if a floor bid is submitted by a floor bidder 508, the process moves to block 804 where the auctioneer receives a notification of the floor bid. Typically, the auctioneer 500 will be notified of the floor bid as a result of the floor bidder 508 providing an indication that he wishes to bid on the item. As with the other decision blocks, if a bid is submitted from a phone bidder 508 at decision block 802(c), the process moves to block 804 and the auctioneer 500 is notified of the phone bid. Thus, when the floor is open for bidding, each time a bid is received from one of the allowed bidders (e.g., online bidders 208 and 210, phone bidders 508 and floor bidders 506), the auctioneer 500 receives a notification of the bid. If no bid is submitted from any of the bidders, however, the process returns to block 800 where the auctioneer 500 continues to wait for additional bids.

Once the auctioneer 500 has received notice of the submitted bids, the auctioneer 500 may accept one of the submitted bids at block 805. Due to their physical presence, floor bidders 206 are immediately aware that a new bid has been accepted because the auctioneer makes a statement to that effect. However, in order to notify the online bidders 208 and 210 that the bid price has been adjusted, the online operator 502 typically will need to update the database 300 using the auction operation client module 304. As a result, the process moves to decision block 806(a) where the online operator 502 determines whether an online bid was accepted. If an online bid was accepted, the process moves to block 808(a), where the online operator 502 enters the online bid into the auction operation client module 304. In some embodiments, this is accomplished by selecting the online bid button 610(c).

If an online bid has not been accepted at block 806(a), the process moves to block 806(b) where it is determined whether a floor bid has been accepted. If a floor bid is accepted at block 806(b), the process moves to block 808(b), where the online operator 502 enters the floor bid into the auction operation client module 304 (by selecting the floor bid button 610(a), for example). Once the bid has been entered by the online operator 502, it auction operation client module 304 passes the data to the application server 302 of the MPLAS, which in turn write the data to the database 300 at block 810. If neither an online bid nor a floor bid is accepted by the auctioneer 500, the process moves to block 806(c) where the online operator 502 determines whether a bid from a phone bidder 206 has been accepted by the auctioneer 500. If so, the process moves to block 808(c), where the online operator 502 enters the accepted bid into the auction operation client module 304. If for some reason the auctioneer has not accepted any of the submitted bids, the process returns to block 800 where the live auction event waits for additional bids to be submitted.

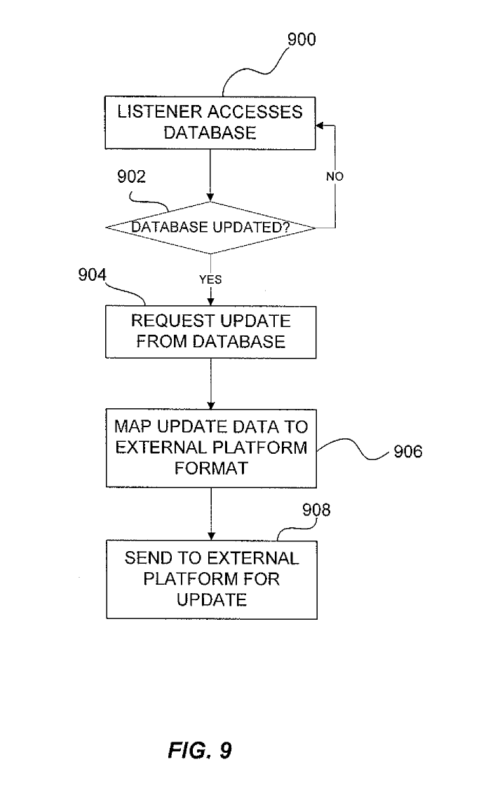

After the accepted bid (e.g., online bid, floor bid, or phone bid) has been entered into the auction operation client module 304 at one of blocks 808(a), 808(b), or 808(c), the update is then passed by the module 304 to the application server 302. The application server 302 in turn updates the database 300 at block 810. Once the update has been written to the database 300, the process moves to block 812 where the MPLAS 202 processes the update by providing the update to the application server 302, the web server 308 and the external platform interface 312. In one embodiment, the various server components are configured to query the database at regular intervals (every 50 milliseconds, for example) to determine whether any update to the live auction has occurred. In some embodiments, the listener 404 of the external platform interface 312 requests the updated data in the database 300 as described above in connection with FIG. 4. Once the updates have been processed, the updated information is then distributed to the online bidders at block 814. In the case of MPLAS bidders 210 accessing the MPLAS 202 using the bidder client module 306, the updates may be sent by the application server 302. The MPLAS bidders 210 accessing the MPLAS 202 via the web bidding client module 310 may receive their updates via the web server 308. External bidders 208 may receive updates from their corresponding external live auction platform 206 as will be described in more detail with reference to FIG. 9.

Referring now to FIG. 9, the process by which database updates are distributed to external bidders is described. The process begins at block 900 where the listener 404 from the external platform interface 312 accesses the database 300 by requesting updates. If the database 300 has not been updated at decision block 902, the process returns to block 900 and the listener 404 makes another request. If, however, the database 300 has been updated, the process moves to block 904 where the listener 404 submits a query to the database 300 to extract the updated data (e.g., the new bids received into the MPLAS 202). Once the external platform interface 312 has received the updated data set, the mapping module 404 packages the data into a format suitable for the external platform 206 at block 906. In some embodiments, this package takes the form of an HTTP request which updates a web-enabled database associated with the external platform 206. Alternatively, the request could be provided using some other protocol. Once the updated data has been mapped to the proper format for the external platform 206, the data is sent to the external live auction platform 206 at block 908, where it is then distributed to the external bidders 208 according to protocols defined in their respective external live auction platform 206.

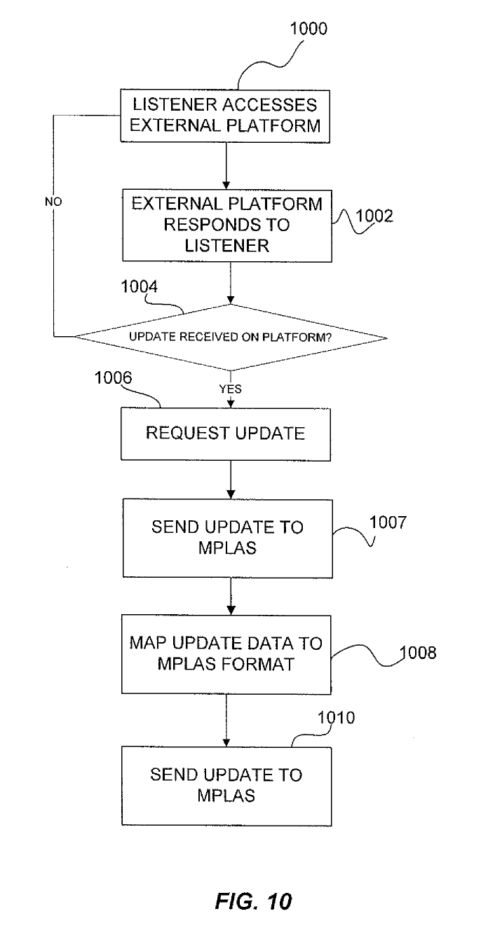

As discussed previously, the MPLAS 202 may be configured to receive bids placed by external bidders 208 on the external platforms 206. FIG. 10 provides an illustration of this process. The process begins at block 1000 where the listener 404 of access the external live auction platform 206 requesting data updates from the platform. The updates may include bids submitted by one or more of the external bidders 208 for the lot being auctioned. Next, at block 1002, the external live auction platform responds to the request indicating whether new data is available. Next, at decision block 1004, if no new data is available on the external live auction platform 206, the process returns to block 1000 and the listener 404 makes its next request at the next request interval.

If new data is available on the external live auction platform 206, the process moves to block 1006 where the listener requests the data update. Next, at block 1007, the external platform 206 responds to the request made in block 1006 by sending the updated data to the external platform interface 312. The data is received by the external platform interface 312 and at block 1008 the data is converted or mapped to the appropriate format for storage in the database 300 of the MPLAS 202. As noted above, the mapping may be performed by the mapping module 404. Once the external data has been converted to the appropriate form, the data is then written to the database 300 at block 1010. In the case where the data received from the external platform 206 is a bid submission from an external bidder 208, the bid is then distributed to the online operator 502 via the auction operation client module 304 for submission to the auctioneer 500.

As previously discussed, certain embodiments of the invention provide bidders with the ability to access and participate in multiple live auction events simultaneously so that they are not forced to choose among items on which they wish to bid. The bidder client module 306 in conjunction with the MPLAS 202 is configured such that MPLAS bidders 210 are able to selectively identify items of interest among many different live auctions and save these items of interest for later use. Further, the bidder client module 306 allows MPLAS bidders 210 to access all of their saved items within a single application window, even if the items are part of different live auction events.

Referring now to FIG. 11, a block diagram illustrates an exemplary environment 1100 in which MPLAS bidders 210 can connect to the MPLAS 202 to concurrently access multiple live auction events 1104. As shown in the figure, multiple live auction events 1104(a) through 1104(d) may be defined within the MPLAS 202. As noted previously, the auction operator client module 304 may be configured to allow auction houses to define and implement their live auction events on the MPLAS 202. Although only four live auction events are shown in the example provided in FIG. 11, many additional live auction events may also be stored within the MPLAS 202. Some of the additional live auction events may take place at the same time as the live auction events shown in FIG. 11, while other live auction events may take place at different times.

Each of the live auction events includes one or more rings. For example, auction event 1104(a) includes five rings, while auction event 1104(b) includes three rings, etc. For ease of reference, in this example, each ring in a live auction event 1104 takes place at substantially the same time. However, in some instances, the different rings in a live auction event may have different starting times. Each ring of the live auction events 1104 is connected to and logically defined within the MPLAS 202. As noted above, each of the rings may be managed by an online operator 502 via the auction operation interface 306.

Also part of the environment is an MPLAS bidder 210. Although only a single MPLAS bidder 210 is shown in this example, a skilled artisan will appreciate that many MPLAS bidders can simultaneously access the MPLAS 202 to connect to the live auction events 1104. Unlike the existing live auction solutions where each bidder can connect to only a single ring (as shown above in FIG. 1), utilizing the client bidding module 304, the MPLAS bidder 210 is able to connect concurrently to any or all of the auctions taking place. In the example provided, MPLAS bidder 210 connects to rings 1, 3, and 5 of live auction event 1104(a), connects to rings 2 and 3 of live auction event 1104(b), connects to ring 1 of live auction event 1104(c) and connects to rings 1, 2, 3, and 4 of live auction event 1104(d). Thus, as is shown in the figure, the MPLAS bidder is not only able to simultaneously connect to multiple rings within the same auction event, but is also able to connect to rings in multiple live auction events 1104.

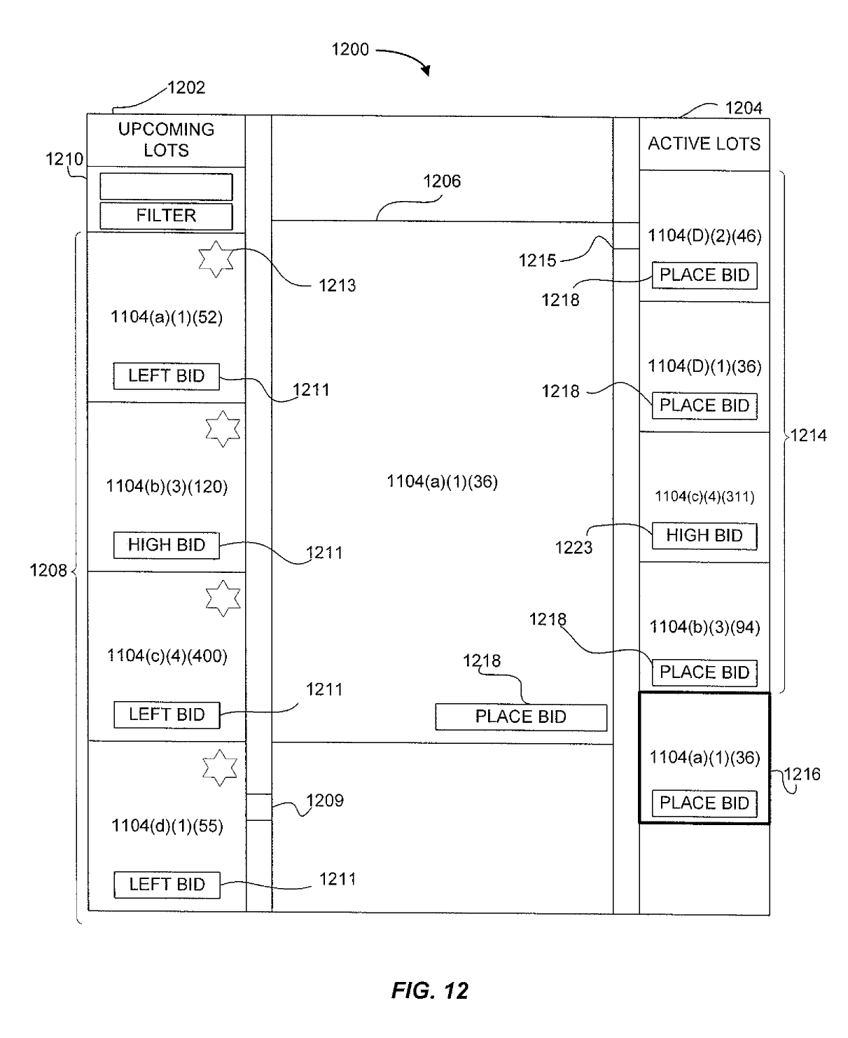

FIG. 12 is an example of a user interface 1200 for the bidder client module 306 which allows the MPLAS bidder 210 to connect to multiple live auctions as described in connection with FIG. 11. The user interface 1200 includes three primary areas: an upcoming lots display area 1202, an active lots display area 1204, and a lot details area 1206. The upcoming lots area 1202 typically displays information about lots in the auction rings which have been loaded into the bidder client module 306. The upcoming lots area typically displays those lots which are not yet up for bidding on the auction floor. The upcoming lots area may include two sub-areas. The first sub-area is the lot display area 1208 in which the individual lots are displayed in a list. In the embodiment provided, the lots are placed in a vertical list and the MPLAS bidder 210 may utilize a scrollbar 1209 to move through the list.

Each item listed in the upcoming lots area 1202 may include one or more action buttons 1211. Selecting the action button 1211 for a particular item/lot allows the MPLAS bidder 210 to place a left bid on that item, as is discussed in further detail below. If a MPLAS bidder 210 has already placed a left bid on an item (and is the current high bidder), the action button 1211 will indicate that the MPLAS bidder has the current high bid as shown with lot 1104(b)(3)(120) (which is the 120th item in RING 3 of auction event 1104(b) from FIG. 11). Each lot displayed in the upcoming lots list may also include a lot save element 1213. The lot save element 213 allows the MPLAS bidder 210 to select items of particular interest to be placed in the “Saved Lots” area associated with the MPLAS bidder 210. In the user interface 1200 provided in FIG. 12, the lot save element 1213 is a star shaped element. When the MPLAS bidder 210 selects the lot save element 1213, its appearance may change (by changing color, for example) so that the MPLAS bidder 210 knows that the lot has been saved.

The upcoming lots area 1202 displays by default all lots from the rings loaded into the bidding client 306. Because there may be hundreds or even thousands of lots in each ring, it can be very cumbersome to scan through the entire list to find an item of interest. In order to address this problem, the upcoming lots area 1202 may also include a lot filtering module 1210. The lot filtering module 1210 allows the MPLAS bidder 202 to filter the lots in the list by parameters selected or provided by the user. In some embodiments, the lots displayed in the upcoming lots list 1202 may be categorized in the database 300. The lot filtering module 1210 may include drop down menus which allow the MPLAS bidder 202 to narrow down the list by categories or sub-categories. Thus, when the MPLAS bidder selects a category filter, the bidding client 306 and/or the MPLAS 202 execute commands which remove all items from the lot display area 1208 except those having the specified category. In other embodiments, the lot filter module 1210 may also allow the MPLAS bidder to enter a search string or search parameters to narrow down the list of lots displayed in the lot display area 1208.

The active lots area 1204 is the portion of the user interface 1200 that displays those lots that are currently being auctioned in one of the live auction events 1104. Each active lot displayed may include information such as the current bidding status, the name of the item, a brief description, the condition of the item, or some other information. The active lots area includes non-selected active lots 1214 which are those displayed which have not been selected by the MPLAS bidder 210 for more detailed information. The active lot area also allows the MPLAS bidder to select a lot to be displayed in the lot details area 1206. In the example provided, lot 1104(a)(1)(36) is the selected lot 1216. Additional details such as a more detailed description and/or additional pictures for the selected lot are displayed in the lot details area 1206.

The MPLAS bidder 202 may place a bid on each lot displayed in the active lots area 1204 at any time the lot is displayed. The bid may be placed by selecting the place bid button 1218 for the desired item. If the MPLAS bidder 210 is already the highest bidder for the item, then the place bid button 1218 changes to a high bidder notification 1223 and the MPLAS bidder 210 is prevented from submitted additional bids until he is outbid. Using the interface 1200 provided by the client bidding module 306 and the MPLAS 202, MPLAS bidders 210 can monitor and/or participate in several live auctions which are taking place at the same time. Although an MPLAS bidder is typically a remote user who is not present on the floor of a live auction event 1104, in certain embodiments, the MPLAS bidder 210 may be present at a live auction event, and be bidding in multiple rings of the event utilizing the client bidding module 306 via an Internet connection and computing device such as a lap top computer, handheld device, or some other type of network-enabled computing device.

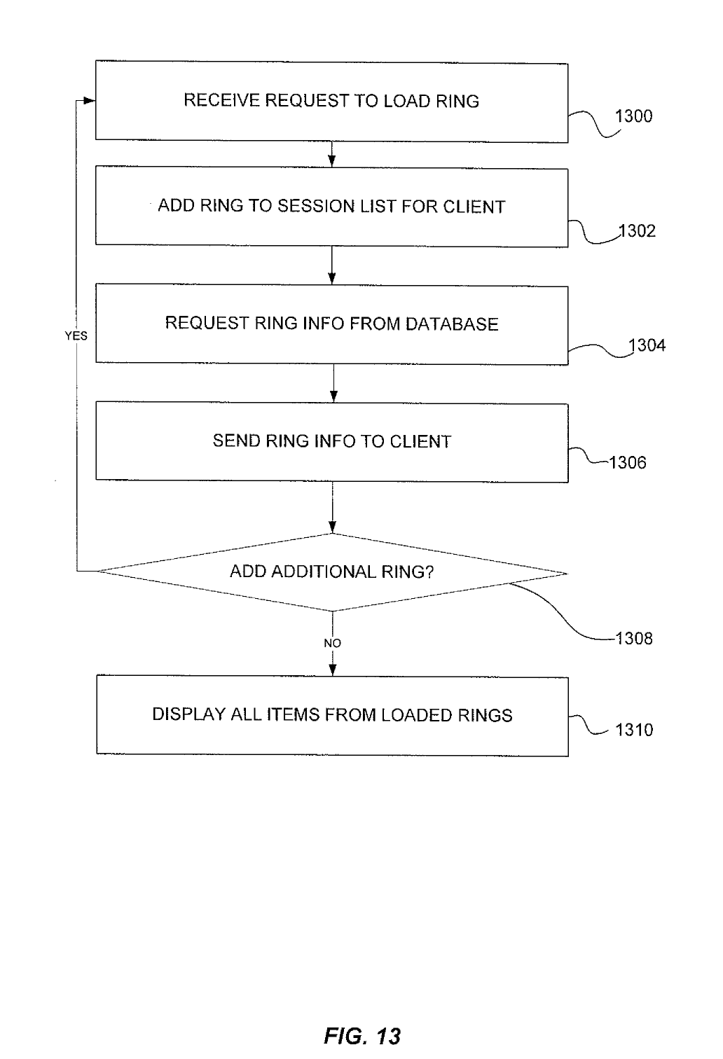

As noted in the discussion of FIG. 12 above, a MPLAS bidder 210 may load multiple live auction events for simultaneous viewing and participation. FIG. 13 is a flowchart illustrating a process for accessing multiple live auctions at the same time. The process begins at block 1300 where the MPLAS 202 receives a request from a MPLAS bidder 210 to load a ring into the client bidding module 306. In response to the request, the MPLAS 202 creates a list of active rings for the MPLAS bidder 210 at block 1302. Next, at block 1304, the application server 302 requests the selected ring data from the database 300 and then sends the ring information to the client bidding module 304 of the MPLAS bidder 210 at block 1306. The process then moves to decision block 1308. If the MPLAS bidder 210 adds an additional ring then the process returns to block 1400. Otherwise, the process moves to block 1410 where the items from the loaded rings are displayed to the MPLAS bidder in via the user interface 1200.

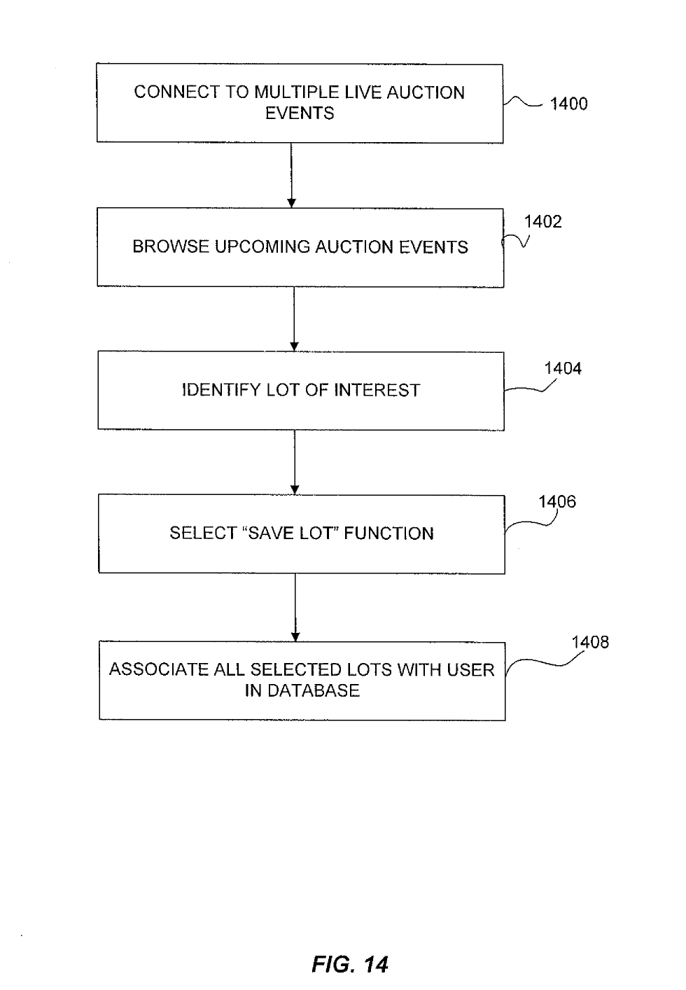

As discussed briefly above, the user interface 1200 of the client bidding module 306 also provides the MPLAS bidders 210 with the ability to specify and select lots from among a plurality of rings and live auction events 1104 to bid on at a later time. FIG. 14 is a flowchart providing an example of a process by which this can occur. The process begins at block 1400 where an MPLAS bidder 210 loads multiple live auction events into the bidding client module 304. In some embodiments, the bidding client module 304 may be configured to provide a list of live auction events 1104 and their associated rings which may be selected by the MPLAS bidder 210 for display in the user interface 1200. The live auction events are stored in the database 300 of MPLAS 202.

The process then moves to block 1402, where the MPLAS bidder browses the list of lots displayed in the upcoming lot area 1202 of the user interface 1200. Next at block 1404, the MPLAS bidder 210 identifies a lot that he wishes to save, and at block 1406 selects the lot save element 1213 to save the lot. After saving the selected lot element 1213, the process then moves to decision block 1408, where selected lot is written to the database 300 in the MPLAS 202.

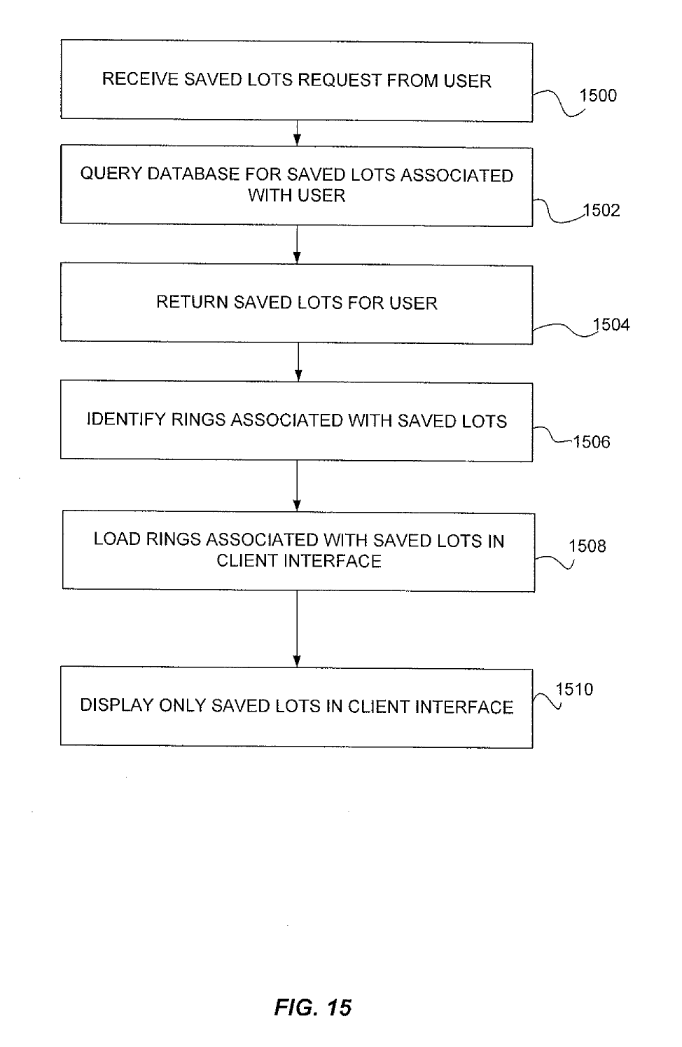

Another embodiments of the invention provides MPLAS bidders 210 with the ability to both participate in multiple simultaneous auctions (by loading multiple rings/auction events) and also limit the list of items displayed in the user interface 1200 to those that the MPLAS bidder fins of interest. This functionality is provided by a “Load Saved Lots” option made available in the bidding client module 306. FIG. 15 is a flowchart demonstrating a method by which a user can target specific lots in multiple auction rings

The process begins at block 1500 where the MPLAS 202 receives a “Load Saved Lots” request from the MPLAS bidder 210 via the bidder client module 306. Next, at block 1502 the application server 302 queries the database 300 for the saved lots associated with the MPLAS bidder 210 making the request. At block 1504, the database 300 returns the lots that have been saved by the MPLAS bidder 210. Next, at block 1506, the MPLAS 202 identifies the rings and/or live auction events 1104 which are associated with the save lots that were returned in block 1504. At block 1508 the application server 302 sends to the bidding client module 306 the rings associated with the saved lots and loads them into the bidding client module 306. Once the rings have been loaded into the bidding client module, at block 1510, the system only displays the saved lots in the user interface 1200 of the bidding client module 306. Thus, the MPLAS bidder 210 is automatically tied into the rings necessary for him to bid on the lots that are of interest to him.

The bidding client module 306 described above is typically a compiled client/server application that is installed over the operating system on the MPLAS bidder's computing device. As noted in FIG. 3, however, MPLAS bidders 210 may also access the MPLAS 202 using the web bidding module 310. Existing web-based bidding live auction bidding interfaces have not been well-suited for the task because of the stateless nature of the web browser. Online live auctions move at a quick pace, and frequent calls to the database are needed to provide accurate and timely information to web-based bidders. Web browsers have not been a suitable solution because bidder would need to “refresh” the browser in order for the new data to be displayed in the web interface. Utilizing development techniques such as AJAX to create more interactive web applications, the web bidding module 310 is able to provide the responsiveness necessary for effective live auction participation.

Referring back to FIG. 3, the web bidding module 310 accesses the MPLAS by making requests to the web server 308 which in turn submits requests to the database 300 based on the client request. With reference to FIG. 16, a more detailed view of web bidding module 310 is provided. The web bidding module 310 typically takes the form of a web browser running in the operating system of a client computing device. The web browser generates a web page 1610 that allows the MPLAS bidder 210 to bid on live auctions by accessing data stored on the MIPLAS 202 via the web server 308.

The web page is typically generated by providing markup language data 1612 (which may be XHTML, HTML, XHTML, or some other markup language) to the web browser. The HTML data 1612 may be provided via a request to the web server 308 of the MPLAS 202 made by the web browser, or it may be generated locally within the browser. The markup language data provides markup and styling information for the web page. The web page 1610 also includes scripting data 1614. The scripting data 1614 may include JavaScript code which is configured to request server updates and/or send data to the MPLAS 202 for data to be displayed within the HTML 1612. The scripting data 1614 is configured to send the requests with a page refresh, thereby allowing the user to participate in the live auction event with needing to refresh the web page.

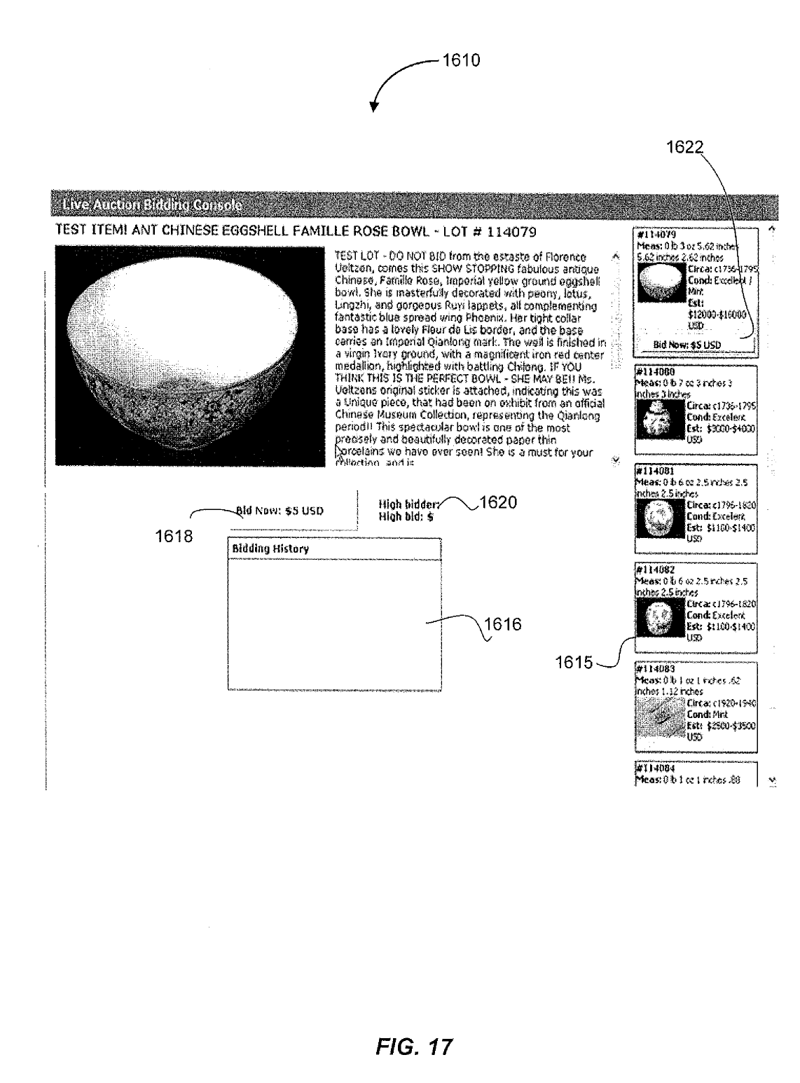

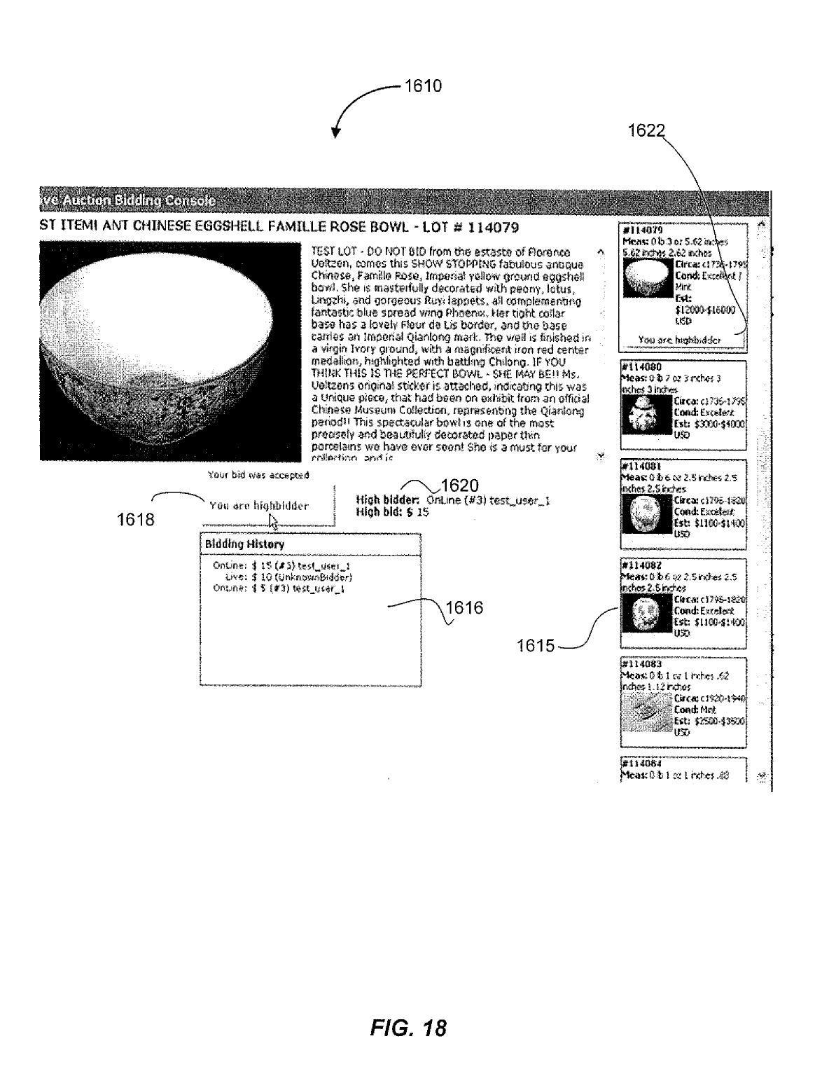

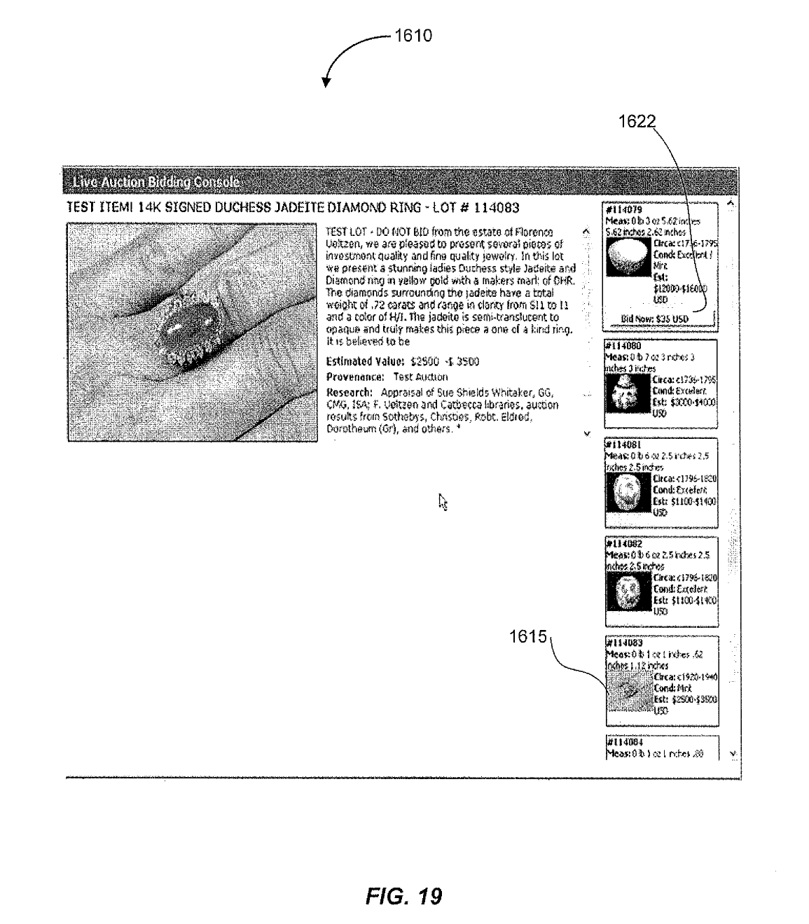

FIGS. 17-19 provide an example of how web page 1610 may be dynamically updated during the bidding process. The generated web page 1610 includes server interface objects which are dynamically adjusted using the scripting data 1614 to receive near real-time updates of the status of the lot up for auction. The web page 1610 includes the list of lots 1615 which may comprise lots available in the live auction. At the top of the list 1615 is the live item currently up for bidding on the auction floor. The live item includes a bidding button 1622 which is a dynamic object which requests data updates from the MPLAS 202 as will be shown in FIGS. 18 and 19. The web page further includes additional dynamic interface objects including a bidding history text element 1616. The bidding history text element receives data from the MPLAS related to the bidding for the current lot. The high bidding and bid amount 1620 also are dynamically adjusted based on the updated to the MPLAS provided by the online operator 502 of the auction operation client module 304. In addition, the web page may also include a second bidding button 1618. In the screenshot shown in FIG. 17, the bidding for the current lot has not yet begun, so the bidding history text element is empty, and the bidding button is set to the minimum bidding amount (five dollars).

Referring now to FIG. 18, bidding has progressed in the auction from FIG. 17. In this example, the MPLAS bidder 210 accessing the web page 1610 has submitted a bid by selecting either bidding button 1618 or 1622. As a result, the bidding buttons 1618 and 1622 have been update to reflect that the MPLAS bidder has submitted the high bid. In addition, as other auction activities are entered into the auction operation module 304 and updates are passed to the database 300, the bidding history object 1616 and high bidder objects 1620 are updated to reflect the current activity. Thus, the bidding history 1616 now shows the previous bids that have been accepted by the auctioneer, and the high bidder 1620 shows that the MPLAS bidder is the high bidder.

Another aspect of the web bidding module 310 allows the MPLAS bidder to review upcoming lots while still monitoring and participating the currently active lot. FIG. 19 provides an illustration of this feature. In this example, the live auction being conducted in FIGS. 17 andl8 is ongoing. However, the MPLAS bidder has selected an upcoming lot from the lot list 1615 to review its details. As a result, the lot details displayed in the center of the web page are no longer the details for the live lot. As a result, the bidding button 1618, the bidding history 1616 and the high bidder information 1620 no longer are displayed (because there are not relevant to the lot displayed above). Nevertheless, the MPLAS bidder 208 is able to bid monitor the progress of the live lot because the bidding button object 1622 is continuously updating based on the activity on the auction floor.

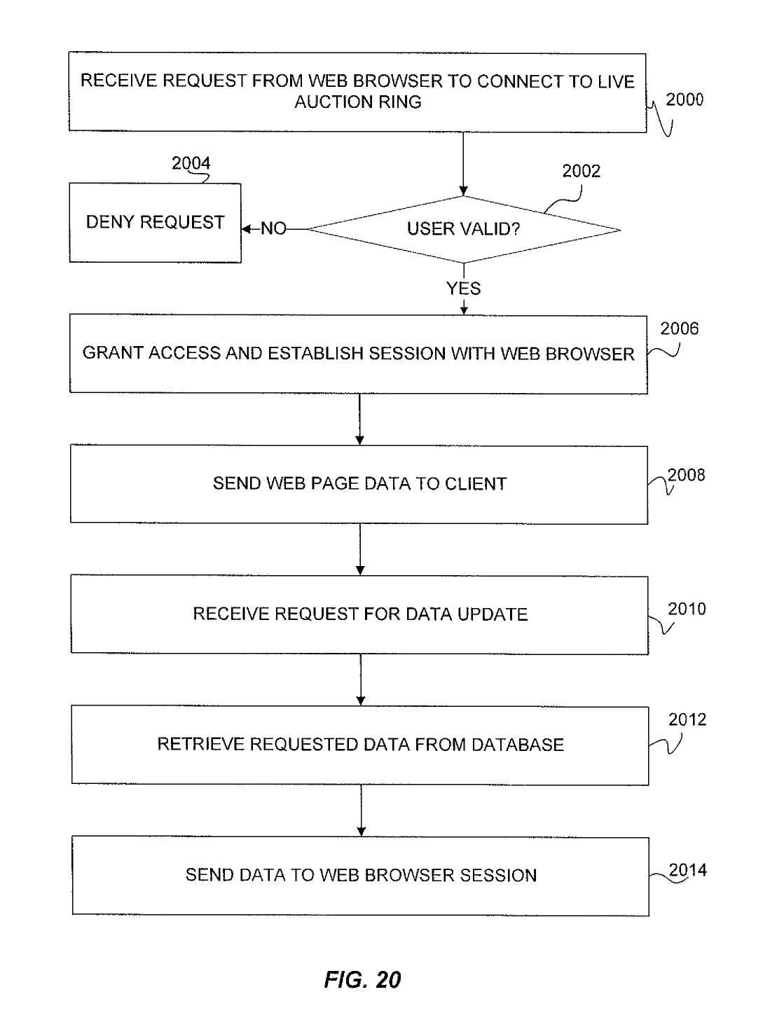

Referring now to FIG. 20, a flowchart illustrates the process by which the live auction events are provided by the web bidding module 310. The process begins at block 2000, where the web bidding client module 310 requests access to the MPLAS 202 and to a live auction offered on the MPLAS 202. This request will typically be received by the web server 308. Next, at block 2002, the MPLAS 202 determines whether the user request is authorized. Typically, this process will include utilizing a challenge authentication mechanism such as a user login name and password. If the request not authorized, the process moves to block 2004 where the request is denied and the process ends there. If the request is authorized, the process moves to block 2006 and the web server 308 (or the web server in conjunction with the application server 302 or some middleware) grants access to establishes a session with the web browser sending the request. Next, at block 2008, the web server 308 sends the bidding web page to the client web bidding module 310. As discussed above, the web page may include both HTML content and scripting content. Alternatively, it may include only scripting content, with the HTML being generated by the browsing software. The javascript content included in the web page creates the dynamic objects in the web bidding module such as bidding history 1616 and the bidding buttons 1618. Next, at block 2010, the dynamic objects on the page send a request for a data update from the server. The request may be a XMLHttpRequest object or an IFrame object, or some other request object. In response to the request, the web server 308 retrieves the requested data from the database 300 at block 2012. Once the data has been retrieved from the database, it is returned to the web page loaded in the web bidding module 310 without reloading the entire page. As noted above, the requests for new data may occur very frequently, so that updates to the database 300 are distributed to the web bidding module 310 with 200 milliseconds of being written to the database 300. Similarly, bids submitted by the MPLAS bidder using the web bidding module 310 may be sent via the XMLHttpRequest object, and these bids may be written to the database 300 where they are distributed to the auction operation client module 306.

FIGS. 21-25 illustrate an example of a left bid process described for a live auction. Throughout the left bid description references are made to particular examples of systems and components previously described herein that could be used to perform the left bid process, but referencing such systems is not meant to limit the scope of the implementation of left bid processing.

Left bids or absentee bids both generally refer to a bid left by someone who wants to bid in the live auction but is unable to attend the auction. Typically, to leave a “left bid” a bidder contacts an auction house before the auction starts and provides their contact/bidder information (e.g., name, phone number, current mailing address, tax exemption number) and a dollar amount bid for each lot that the bidder wishes to bid on. These left bids are then competitively bid into the auction as if the bidder was present. That is, the left bids are bid up incrementally to the maximum of the left bid on behalf of the absentee bidder until other bids exceed the left bid or there are no other competing bidders. In live auctions it is very common for absentee bidders to win lots for substantially less than their set left bid. Because it takes a certain amount of time to compile and organize the left bids, typically left bids for a lot are not accepted just before auctioning the lot, or not even just before start of the auction. Instead, there is a designated time period ending at a predetermined time before the auction starts (e.g., 1-2 hours or more) during which left bids are accepted for any of the lots in the auction. Accordingly, left bids may be required to be placed many hours before a lot the bidder is interested in comes up for auction.

Typical timed model auctions used for online auctions are set up where items for auction are “featured” and more searchable when they are within several hours of the items nearing the completion of their designated auction duration. Normally, about 50% of all bids placed on these items occur on the final day of the auction due to the configuration of the auction hardware and software, and based on how the bidders want to competitively bid at the last minute before the auction for an item closes. No bidder wants to wait for hours or days, instead they focus on the last few hours remaining in the auction. Live auctions online, however, close down left bidding on the day of the auction hours before the first lot is sold. Bidders are told they cannot leave a left bid so they are forced to watch the entire auction waiting for items of interest to “go live” which could be hours away. This issue causes the live auctioneers to lose up to 50% of the bids they might have received on their items. Most bidders happy with the timed online model system will not participate if they have to wait hours waiting for their item to come up.

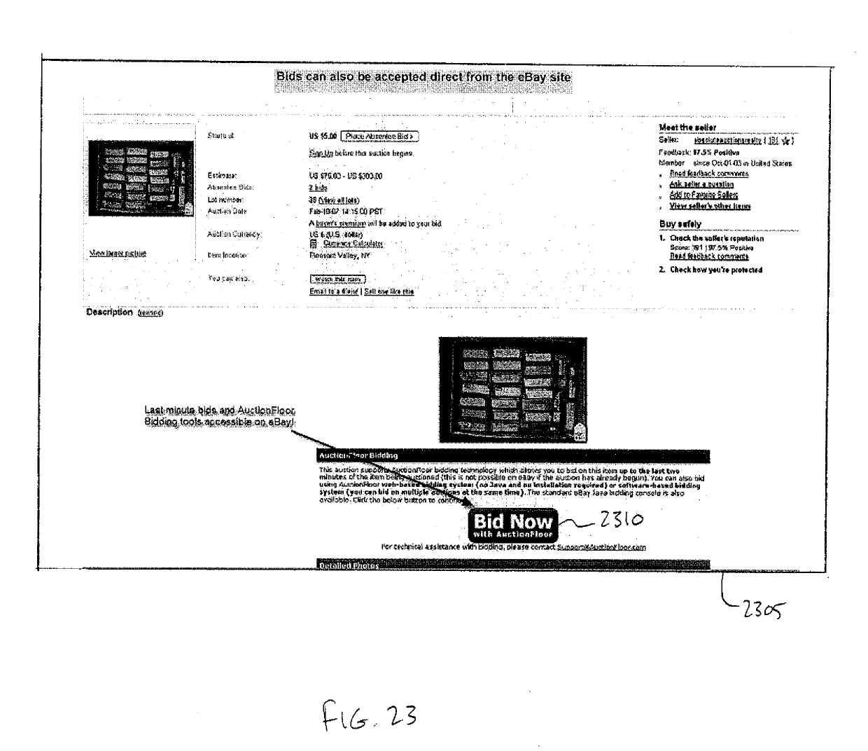

FIG. 21 illustrates a process 2100 that allows a bidder to submit an online left bid on a lot in a live auction. Normally when left bids are accepted before the auction they are manually handed to a live clerk and that clerk presents the bids when the auctioneer reaches the item with left bids. In process 2100, the left bids are integrated into the bidding platform and presented in real time when the items comes up for auction live, no clerk is involved in the process. In particular, at block 2110, process 2100 displays live auction information including an option to enter a left bid for an item or lot that is going to be auctioned in a live auction. In some embodiments, the live auction information may be displayed in a bidding system user interface displayed using the bidder client module 306 or the web bidding client module 310 (FIG. 3). The live auction information and the option to enter a left bid may be displayed in a user interface, or a portion thereof. Two examples of user interfaces displaying live auction information that include options to enter left bids are illustrated in FIGS. 22 and 23 and described further hereinbelow.

Referring again to FIG. 21, at block 2115 the option is selected for placing a left bid. Selecting the left bid option may include selecting a left bid button using a computer pointing device (e.g., a mouse, roll-ball, touchscreen, speech recognition software, or a tablet) or a computer keypad. that is displayed on the user interface, which then may display another user interface or may display data entry fields to enter left bid information. As one of skill in the art will appreciate, such an option may not be named “left bid” but instead be any selection option that allows a user to enter a left bid. For example, in some embodiments selecting a left bid option may simply include selecting a predefined left bid entry space displayed on the user interface. In block 2120, the process 2100 displays a left bid user interface for entering left bid information. Left bid information may include a desired maximum bid as well as other bid submission information. In some embodiments, left bid information also includes submission timing information that indicates when a live bid should be competitively bid, for example, as soon as the item is available, or just before the auction closes for the item. In such cases, the user interface may also include a selection for entering the timing information. In different embodiments, the left bid user interface may be displayed in the same display (or user interface) as the live auction information, for example, a portion of the user interface. In other embodiments the left bid user interface may be displayed separately from the live auction information, for example, it may be displayed in a pop-up window. At block 2125, left bid information is entered into the left bid user interface. Typically, left bid information is entered into a user interface of the web bidding client module 310 or the bidder client module 306 using a keyboard or keypad. At block 2130 the left bid information is stored, for example, in the MPLAS 202 database 300, which is stored on a memory component, such as in RAM, or on a disk storage medium, for example, an optical or magnetic hard drive.

At block 2135 left bid information is displayed on a user interface. This allows the bidder to verify that the entered left bid information is correct. If it is not, the left bid information can be re-entered. At block 2140, the process 2100 transforms the left bid information into live bid information. This transformation may include changing the format of data so it will be correctly displayed by the auction operation client module 304 at the auction house. Also, the live bid information is based on the maximum bid and any submission timing data entered by the user. Lastly, at block 2145 the process 2100 provides a live bid on the item to the live bid auction, where the live bid is based on the live bid information. The live bid may be provided at certain times during the time period when the item of interest is being auctioned in accordance with any submission timing information entered by the user. While the item of interest is being auctioned, one or more competitive live bids may submitted by process 2100 until the maximum bid value is reached or there are no higher competing bids. Using the above-described process, left bid may be submitted up to selected time point (e.g., one second, thirty seconds, one minute, five minutes or more) before the item comes up for auction, rather than hours before the auction starts and many hours before the item of interest is auctioned.

FIG. 22 illustrates one embodiment of a user interface 2205 that may be provided by the MPLAS 202 of AuctionFloor.com that displays live auction information, including an option 2210 to enter a left bid. In this example, the user interface is in the form of an online catalog. Bids can be placed up to 1 minute before the lot sells live. This user interface (online catalog) is linked to the auctioneers bidding client in under 200 ms. In this example, the left bid option is selected by selecting the entry space 2210 and entering a maximum bid amount. The entered left bid information is displayed in entry space 2210 so that the user can confirm the accuracy of the entry. Selecting the “Place Bid” button 2215 submits the left bid for storage on the MPLAS 202 and further processing which converts the left bid into a live bid. In this embodiment, the user interface displays the highest absentee bid 2220. When another user has a higher left bid, the bidder receives instant feedback and will be asked to bid again.

FIG. 23 illustrates another embodiment of a user interface 2305 that displays live auction information. Interface 2305 is provided by another online auction company, eBay, an external live auction platform 206. The eBay interface also displays an “Buy Now with AuctionFloor” option button 2310 to enter a live bid. In this embodiment, selecting the option button 2310 invokes processing that displays a user interface provided by the MPLAS 202 for the item in which a left bid can be entered. In one example, using the above-described systems and processes, a bidder is connected to the ebay external live auction platform 206 so that bids placed using the “Bid Now” button 2310 are included on eBay and available to the bidder in MY EBAY. Typically the external live auction platform 206 to the MPLAS 202 are owned and operated by two separate companies. The selection of the “Bid Now” button may be monitored to identify the transfer from the external live auction platform 206 to the MPLAS 202, and this information may be used to determine compensation schemes between the two companies.

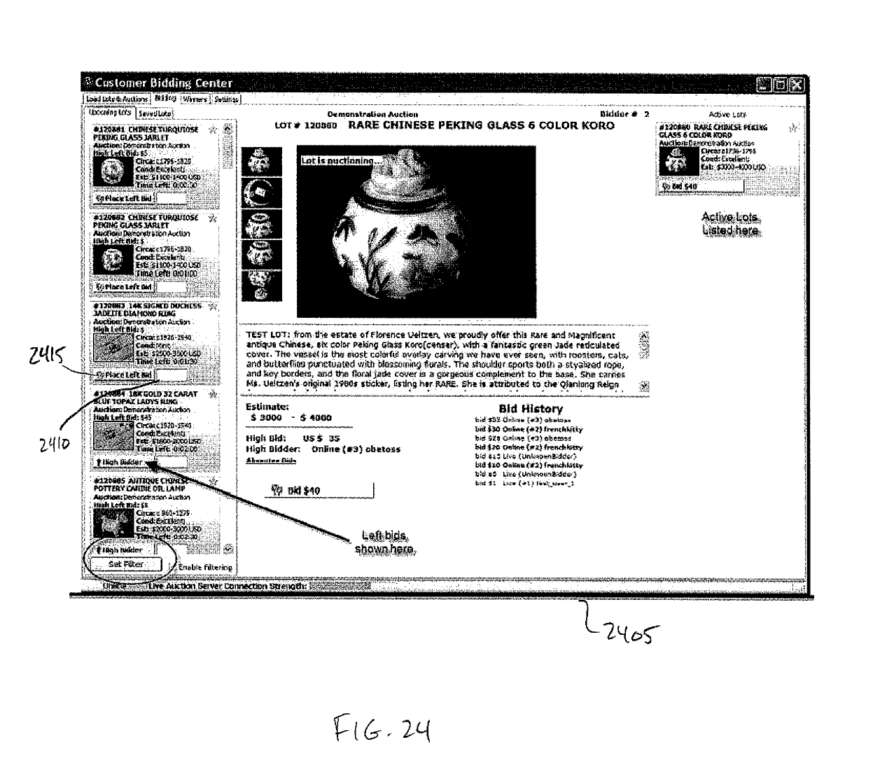

FIG. 24 illustrates an example of a user interface 2405 that may be provided by the client bidder module 306 or by the web bidding client module 310. Absentee or left bids can be placed on items using a customer client up to 1 minute before the item going live. Note in this user interface the bidder (or customer) can also monitor the bids in real time. If the button on the left says “Place Left Bid” then the bidder is NOT the high bidder or he has not attempted to leave a bid. When the button says “High Bidder” the bidder using this client is the current high bidder and will win the item if no other bids are accepted. This can change in real time. The user interface 2405 includes an option to enter a left bid in entry space 2410 and submit the left bid with “Place Bid” button 2415.

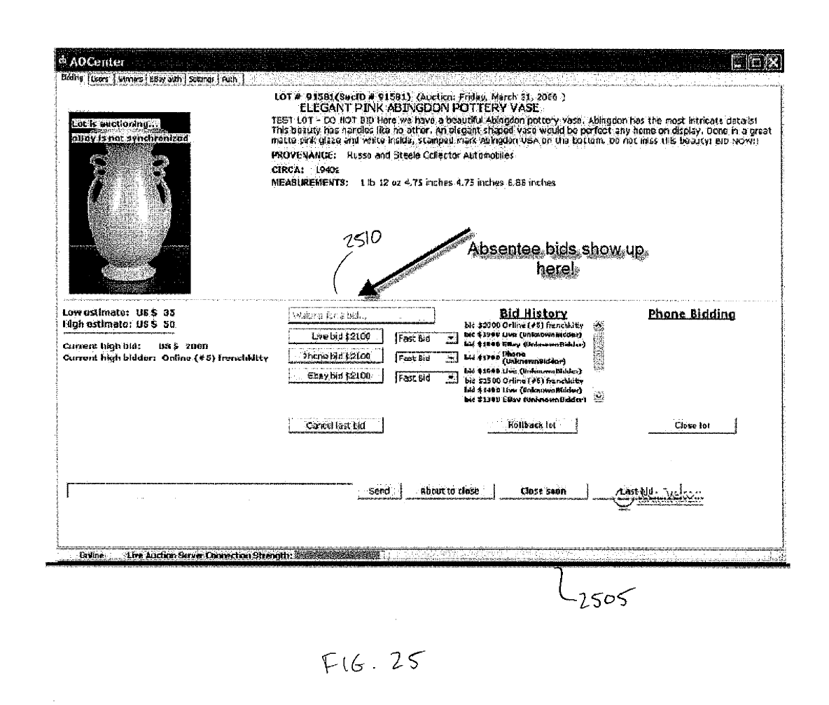

FIG. 25 illustrates an example of a user interface 2505, which is also referred to as an online catalog, that may be displayed at the auction house by the auction operation client module 304. All left bids from an external live auction platform 202 (e.g., ebay), the client bidder module 306 (e.g., AuctionFloor), and the web bidding client module 310 are routed to the auctioneers bidding client shown here. Note the arrow pointing to the button. That button will show a price and become highlighted when any left bid is available. The auctioneer clicks the button to accept it. In this example, all live bids from eBay and AuctionFloor also appear in this button if available. In all cases, only the best bid shows. In the case of 10 bids arriving at the same time, it is based on first in and then best price so that losing bidders are excluded and only the best price (bid) is shown. The auctioneer sees the bids in our bidding client and accepts them when the button lights up. In one exemplary embodiment, on ebay a special button called BID LIVE NOW links an eBay bidder to the MPLAS 202 servers so left bids can be accepted even when eBay turns off the feature on their end.

Timed model bidders who use online auction systems such as eBay.com prefer to know the exact time when an item (or lot) will sell. Normally a bidder flags items they are interested in bidding on, and then when bidding for that item is almost over, the bidder submits bids to try and buy the item just before it closes. This is done normally to prevent placing advance left bids which can create more left bids from competing bidders who are also watching the item. By waiting until the last minute, the bidder can reduce the competing bids and obtain the item at a better price. In a live auction however, each lot is controlled by the auctioneer who closes each lot based on number of bids and other factors. Because of this, existing online auction systems cannot estimate the time an item will sell when it is a live auction item. Worse, current online auction systems normally estimates all lots +12 hours after the auction begins which becomes meaningless information for bidders.

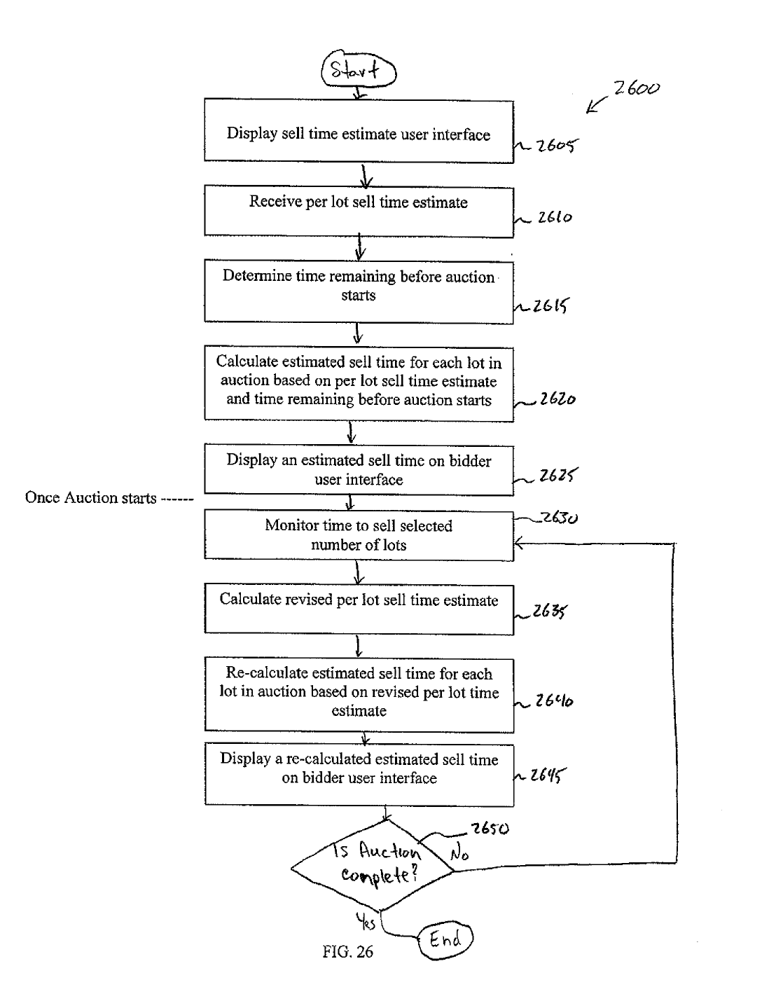

In reference to FIGS. 26-32, processes and systems are described that provide time estimates for when an item will be auctioned, and how much time remains once an item is being auctioned. These processes and systems estimate when each item will sell in the live auction. In some embodiments, the time estimates may be provided as soon as the auction is posted on the network bidding system (e.g., an MPLAS 202 shown in FIG. 3 such as the system of AuctionFloor.com). The time estimates can be available in any user interface connected to the MPLAS 202 including the online catalogs, web based clients (e.g., using web bidding client module 310), a C++ CBC powerbased bidding client (e.g., using bidder client module 306) or an online catalog provided in conjunction with the MPLAS 202. By providing such time estimates, bidders know when to bid on an item they want without constantly monitoring the auction, even if the auction last for hours. Typically this creates more bidding for live auctions.

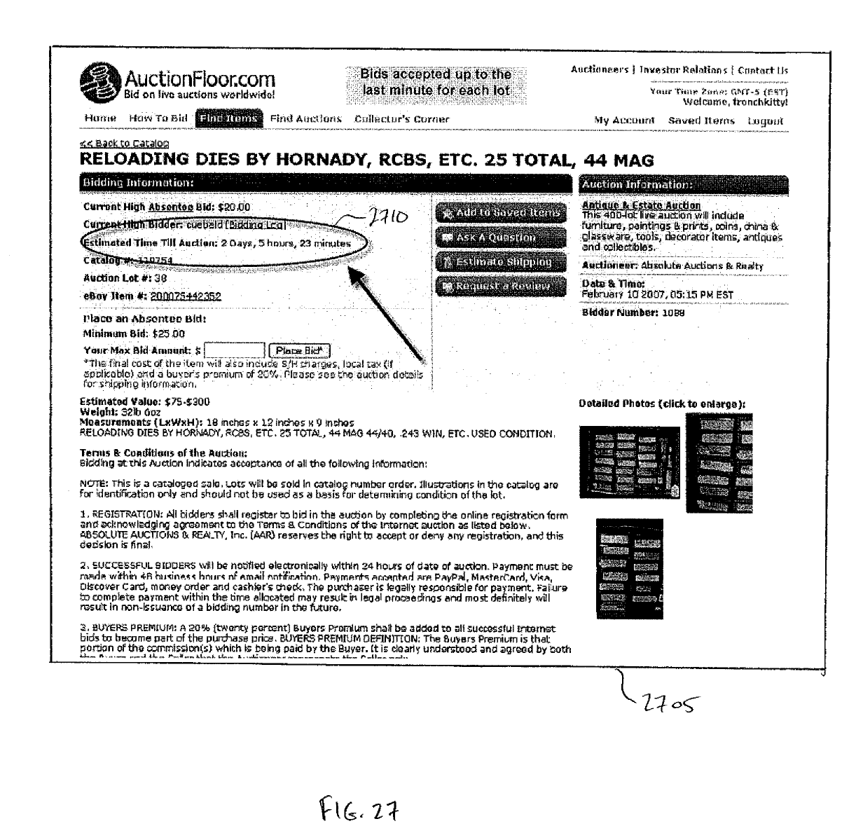

FIG. 26 is a flowchart of a process 2600 that provides time estimates of when a lot is going to be auctioned. The process can provide, in various embodiments, a time estimate of when a particular lot is going to be auctioned or a time estimate of when a particular lot is going to be sold (or close). The time estimate process 2600 starts and at block 2605 it displays a sell time estimate user interface, an example of which is illustrated in FIG. 27. The auctioneer estimates the amount of time it will take to sell each lot during the auction based on many factors which can include, for example, the auctioneer's experience, time deadlines for completing the auction, or the particular contents of the lot. For example, the auctioneer may define that it will take 40 seconds to sell each lot and then enters a per lot sell time in his members area of 40 seconds. There may be a default per lot sell time defined on the user interface that is used in the auctioneer does not, for whatever reason, define a per lot sell time estimate.

At block 2610, the time estimate process 2600 receives the per lot sell time estimate. At block 2615 the process determines the time remaining before the auction starts. When the auction is set up, typically the auction start time is defined, and the process determines can determine the time remaining before the auction start time based on a current time input and the defined auction start time.

At block 2620, the process 2600 calculates the sell time for each lot in the auction based on the per lot sell time estimate and the time remaining before the auction starts. For example, if the per lot sell time estimate is 40 seconds and auction will begin in five hours, the first lot will go on auction in 5 hours and is estimated to be sold in 5 hours and 40 seconds. The 100^{th} lot would have a go on auction time estimate of 5 hours +66 minutes (6 hours 6 minutes) and a sell time estimate of 6 hours 6 minutes and 40 seconds. The process then may at block 2625 display an estimated auction time and/or a sell of each lot in the auction to potential bidders, for example bidder's using the bidder client module 306 or those using the web bidding client module 310. One of skill in the art will appreciate that there are other estimating techniques that also can be incorporated in the time estimate process. For example, the process monitors the sell time of every lot sold (or every other lot, or every third lot, or every 10 lots, etc.) and uses the actual sell time to adjust the sell time estimates for the subsequent lots.

Once the auction starts, at block 2630 the time estimate process 2600 begins to monitor the actual time it takes to sell the lots so that it can re-asses any time estimates provided to bidders. A selected number of lots that have been sold are monitored (e.g., 25) and at block 2635 the process calculates a revised per lot sell time estimate using the time it took to sell the selected number of lots. At block 2640 the process re-calculates time estimates (e.g., sell time or auction time of lot) based on the revised per lot time estimate. Then, at block 2645 process 2600 displays on the bidder's user interface a re-calculated estimated sell time (and/or auction time) for each lot. At block 2650 the process determines if the auction is complete (e.g., based on whether all the lots have been sold or based on a defined input from the auctioneer indicating the auction is complete). If the auction is complete, process 2600 ends, if not, the process may loop back to block 2630 and continue to monitor the time it takes to sell a selected number of lots. This process 2600 may operate real-time or near real-time so that the bidder's have accurate information on the sell-time aspects of each lot which allows them to bid competitively.

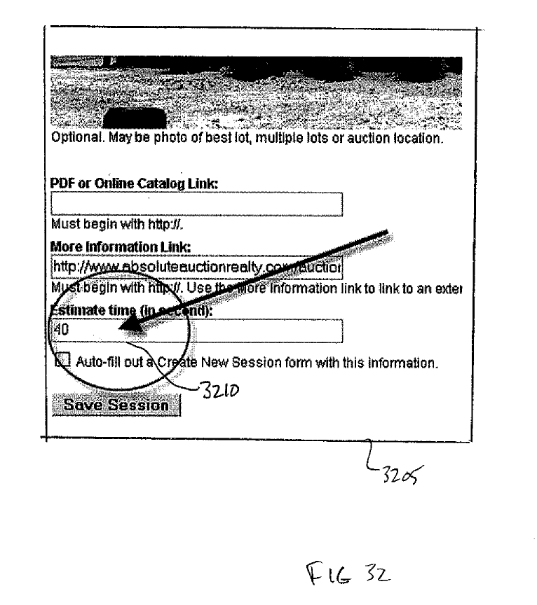

FIG. 27 is an example of a user interface 2705 connected to the MPLAS 202 that displays time estimate information 2710. This example illustrates an AuctionFloor.com online catalog interface that can be provided by the web bidding client module 310. Here, the estimated time to auction is displayed, along with other auction information, e.g., item description, current high absentee bid, current high bidder, auction lot number, and an interface for entering a left or absentee bid. In one embodiment, the estimated time until the item will sell at auction may be estimated based on input received from the auctioneer (for example, see FIG. 32) and/or from an estimation process (e.g., process 2600 in FIG. 26).

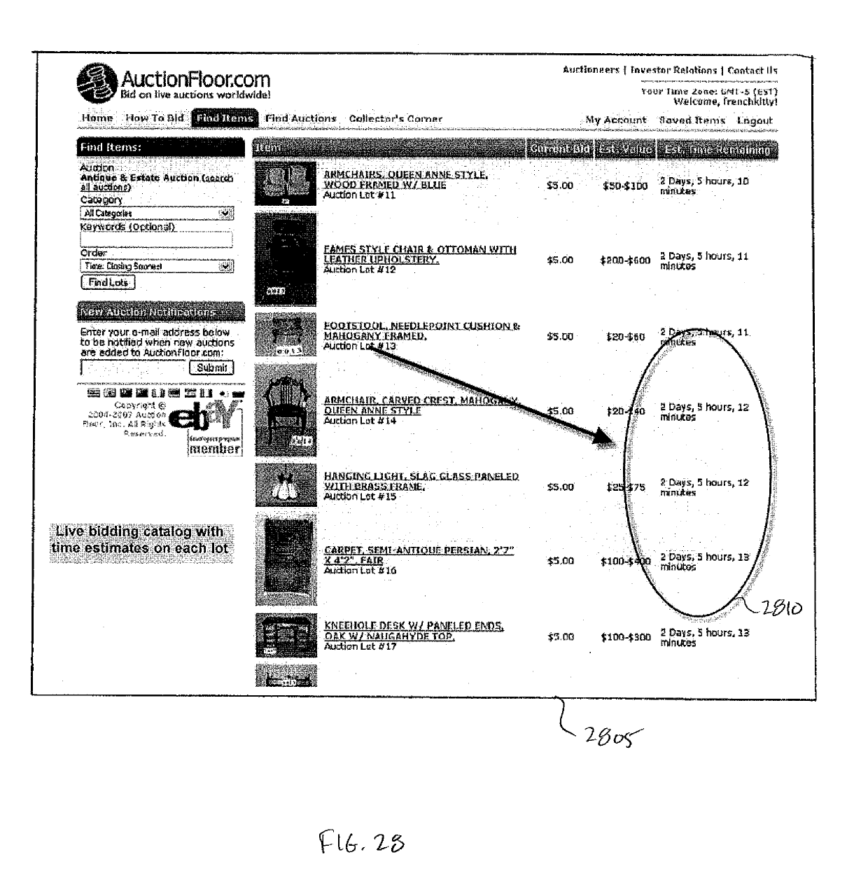

FIG. 28 is another example of a web based user interface 2805 that is connected to the MPLAS 202 that displays time estimate information 2810. In particular, FIG. 28 illustrates an AuctionFloor.com online catalog that shows numerous items and action information associated with each item. For each item, an estimated selling time has been calculated and is displayed. The estimated time until the item will sell at auction may be estimated based on input received from the auctioneer (for example, see FIG. 32) and/or from an estimation process (e.g., process 2600 in FIG. 26).

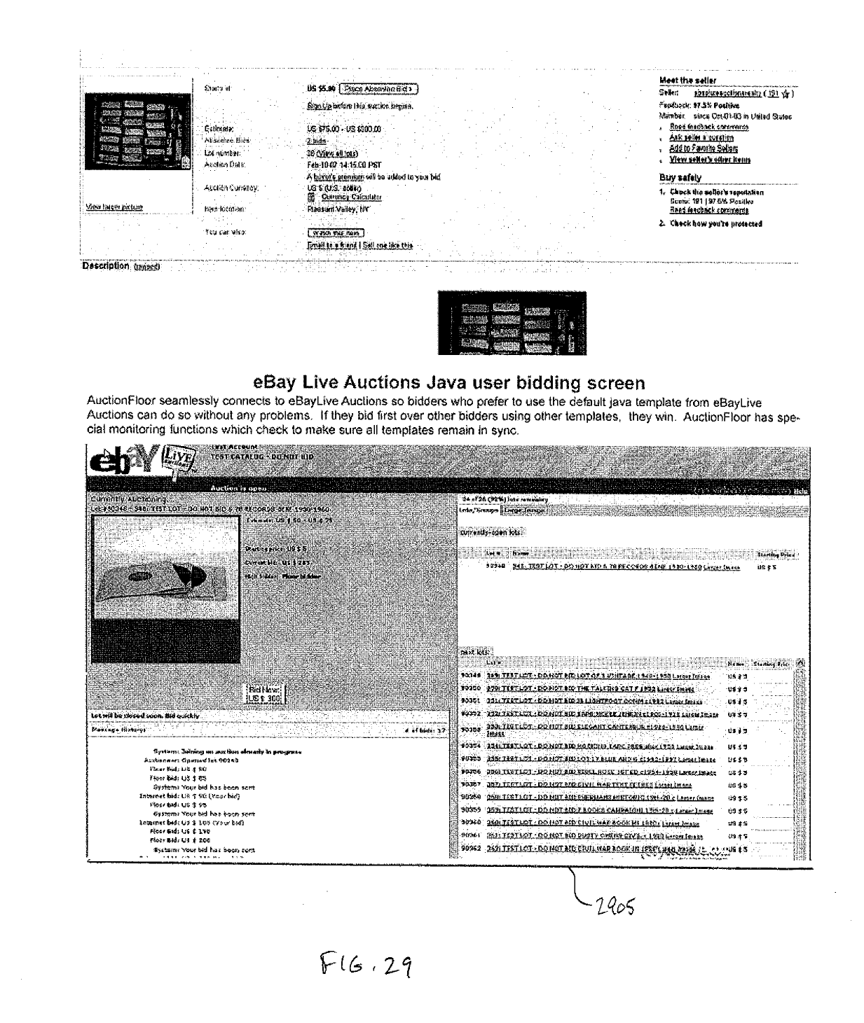

FIG. 29 is an example of an eBayLive Auctions interface (an external live auction platform 206) that displays time estimate information. Typically, time estimates of when the lot will sell are not provided to the interface 2905 of an external live auction platform 206 because the external platforms may not support displaying time estimates. In some embodiments, the external live auction platform 206 may coordinate its interface with the time estimate functionality supported by the MPLAS 202. In such cases, the MPLAS 202 can provide time estimate information to the external live auction platforms for display in an external live auction platform user interface.

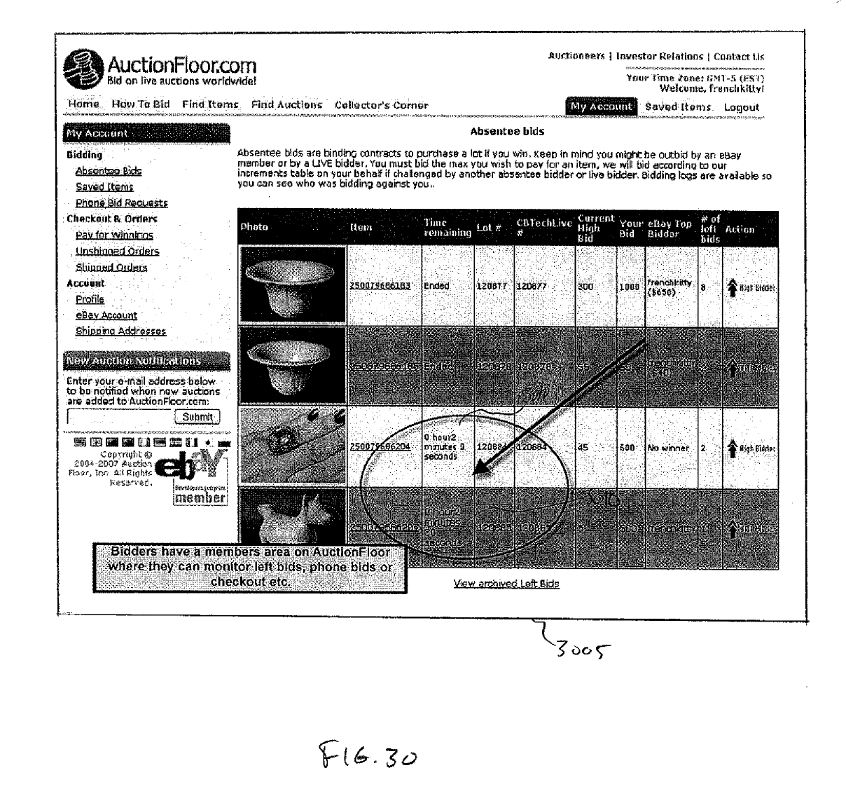

FIG. 30 is another example of a user interface 3005 that displays time estimates 3010 for each left bid or saved lot. This particular example illustrates an AuctionFloor.com interface 3005 that can display multiple items and auction information associated with each item, for example, time remaining, lot number, CBTechLive#, current high bid, your bid, eBay top bidder, number of left bids, and an “action” status.

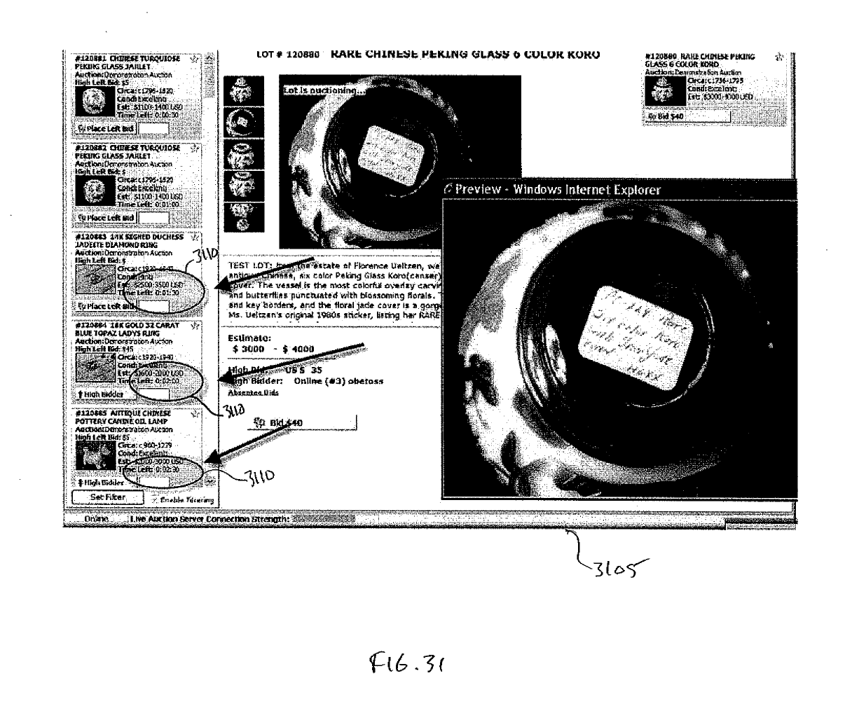

FIG. 31 is an example of another user interface 3105 of a bidder client module 306 connected to the MPLAS 202 that displays time estimates 3110 for the time left in the auction of each item of interest of a live auction. To configure the user interface, a bidder can select multiple items that are being auctioned at various live auctions, and the interface 3105 displays auction information for each item, including time to sell estimates.

FIG. 32 is an example of a user interface 3205 that an auction house or an auctioneer 500 may use to enter a time estimate for running the live auction. The auctioneer 500 (or the online operator 502) from the members area input section (e.g., the auction operation client module 304) assigns a factor of how fast he runs his auction. The same factor may be assigned to all of the lots, or an individual factor may be assigned for each lot. In some embodiments, the same factor is assigned to groups of lots that the auctioneer believes will take about the same time to sell. The factor is processed by the MPLAS 202 and used to determine an estimated sell time for each item. The estimated sell time may be provided to bidders connected to the bidder client module 306 and the web bidding client module 310 and displayed in user interfaces for each user. The MPLAS 202 can also test for this by monitoring his hourly run speed and condensing it to a time per lot in seconds. Estimated time remaining before the item is sold may be estimated by first estimating how much time remains until the auction begins then adding this factor 3210 (40 second in this example) to each lot. Even with auction delays an auctioneer normally maintains a predictable run rate per lot which can be estimated. In some embodiments, the estimation process may automatically adjust the lots to the previous lots. In other embodiments, each lot is set to the factor the auctioneer 500 defines.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A system for providing concurrent access to a plurality of live auctions on a communications network, the system comprising:
a multi-platform live auction system configured to provide live auction services to a plurality of concurrent live auction events, the mutil-platform live auction system comprising an application server configured to connect to a database storing information related to the plurality of live auction events;
a client bidding module configured to concurrently connect the plurality of live auction events by establishing a network connection with the application server in order to request updated data from the database,
wherein the client bidding module is further configured to receive a selection of one or more items from a first live auction event and the one or more items from a second auction event as a saved lot grouping and wherein the application server is further configured to save the received selection in the database;
wherein upon a request from the client bidding module for the saved lot grouping, the application server is further configured to automatically load the first and second auction events into the client bidding module.

2. A computer-implemented method of providing concurrent access to a plurality of live auctions, the method comprising:
loading a first live auction ring into a memory of a client bidding module; and
loading a second live auction ring into the memory; and
concurrently displaying an auction of a first lot in the first live auction ring and an auction of a second lot in the second live auction ring.

3. The computer-implemented method of claim 2, wherein concurrently displaying the auction of the first and second lots comprises updating progress of the auction of the first lot and the auction of the second lot.

4. The computer-implemented method of claim 3, wherein updating progress of the auction of the first lot and the auction of the second lot comprises modifying at least one interface element based at least in part on the progress of the auction of the first lot and the auction of the second lot.

5. The computer-implemented method of claim 4, wherein modifying the at least one interface element comprising displaying a current bid price in the at least one interface element.

6. The computer-implemented method of claim 4, wherein the modifying the at least one interface element comprises displaying a current high bidder in the at least one interface element.

7. The computer-implemented method of claim 4, wherein the at least one interface element comprises a bidding button.

8. The computer-implemented method of claim 4, wherein the at least one interface element comprises a bidding history object.

9. The computer-implemented method of claim 4, further comprising:
receiving from a bidder a first bid on the first lot; and
receiving from the bidder a second bid on the second lot,
wherein the status of the first bid and the second bid are concurrently displayed to the bidder.

10. A computer-implemented method of providing simultaneous access to a plurality of live auctions over a communications network, the method comprising:
receiving a request from a potential bidder to establish a connection;
granting the request to establish the connection;
receiving a request from the client device for a first live auction ring;
adding the first live auction ring to a list of requested rings;
receiving a request for a second live auction ring;
adding the second live auction ring to the list of requested rings; and
sending the first auction ring and the second auction ring to the potential bidder.

11. The computer-implemented method of claim 10 further comprising:
loading the first auction ring and second auction ring into in a client bidding module associated with the potential bidder; and
displaying the data from the first auction ring and the second auction ring in a user interface of the client bidding module.

12. The computer-implemented method of claim 11 wherein the sent data comprises lot data indicative of items to be auctioned in the first live auction ring or the second live auction ring.

13. The computer-implemented method of claim 12, wherein the lot data comprises upcoming lot data.

14. The computer-implemented method of claim 13, wherein the lot data comprises active lot data.

15. The computer-implemented method of claim 14, wherein the active lot data comprises data related to a first item from the first ring and a second item from the second ring, wherein the first item and the second item are being auctioned in the live auction.

16. The computer-implemented method of claim 15, wherein the data related to the first item from the first ring comprises bidding data.

17. The computer-implemented method of claim 16, wherein the bidding data is updated at least every 200 milliseconds.

18. The computer-implemented method of claim 13, wherein the upcoming lot data comprises data related to a first item from the first ring, the first item having not been brought forth for bidding.

19. The computer-implemented method of claim 10 further comprising:
receiving a request to save one or more items from the first live auction ring and one or more items from the second live auction ring as a saved lot grouping.

20. The computer-implemented method of claim 19 further comprising:
saving in a database the one or more items from the first live auction ring and the one or more items from the second auction ring as the requested saved lot grouping; and
associating the saved lot grouping with the potential bidder requesting the saving.

21. The computer-implemented method of claim 20 further comprising:
receiving a request for the saved lot grouping from the potential bidder;
querying the database to retrieve the requested saved lot grouping;
returning the requested saved lot grouping in response to the query; and
sending the saved lot grouping to the potential bidder.

22. The computer-implemented method of claim 21, further comprising terminating and reestablishing the connection with the potential bidder prior to receiving the request for the saved lot grouping from the potential bidder.

23. The computer-implemented method of claim 21, wherein sending the saved lot grouping to the potential bidder comprises:
loading the first live auction ring and the second live auction ring; and
displaying the items in the saved lot grouping.

24. A computer-readable medium comprising computer-executable instructions which when executed cause a computing device to perform a method of providing concurrent access to a plurality of live auctions over a communications network, the method comprising:
receiving a request from a potential bidder to establish a connection;
granting the request to establish the connection;
receiving a request from the client device for a first live auction ring;
adding the first live auction ring to a list of requested rings;
receiving a request for a second live auction ring;
adding the second live auction ring to the list of requested rings; and
sending the first auction ring and the second auction ring to the potential bidder.

25. The computer-readable medium of claim 24 further comprising:
loading the first auction ring and second auction ring into in a client bidding module associated with the potential bidder; and
displaying the data from the first auction ring and the second auction ring in a user interface of the client bidding module.

26. The computer-readable medium of claim 25, wherein the sent data comprises lot data indicative of items to be auctioned in the first live auction ring or the second live auction ring.

27. The computer-readable medium of claim 26, wherein the lot data comprises upcoming lot data.

28. The computer-readable medium of claim 27, wherein the lot data comprises active lot data.

29. The computer-readable medium of claim 28, wherein the active lot data comprises data related to a first item from the first ring and a second item from the second ring, wherein the first item and the second item are being auctioned in the live auction.

30. The computer-readable medium of claim 29, wherein the data related to the first item from the first ring comprises bidding data.

31. The computer-readable medium of claim 30, wherein the bidding data is updated at least every 200 milliseconds.

32. The computer-readable medium of claim 27, wherein the upcoming lot data comprises data related to a first item from the first ring, the first item having not been brought forth for bidding.

33. The computer-readable medium of claim 24 further comprising:
receiving a request to save one or more items from the first live auction ring and one or more items from the second live auction ring as a saved lot grouping.

34. The computer-readable medium of claim 33 further comprising:
saving in a database the one or more items from the first live auction ring and the one or more items from the second auction ring as the requested saved lot grouping;
associating the saved lot grouping with the potential bidder requesting the saving; and
terminating the connection with the potential bidder.

35. The computer-readable medium of claim 34 further comprising:
receiving a request for the saved lot grouping from the potential bidder;
querying the database to retrieve the requested saved lot grouping;
returning the requested saved lot grouping in response to the query; and
sending the saved lot grouping to the potential bidder.

36. The computer-readable medium of claim 35, wherein sending the saved lot grouping to the potential bidder comprises:
loading the first live auction ring and the second live auction ring; and
displaying the items in the saved lot grouping.

37. A system for providing concurrent access to a plurality of live auctions on a communications network, the system comprising:
means for providing live auction services to a plurality of concurrent live auction events, the means for providing live auction services comprising means for connecting to a means for storing information related to the plurality of live auction events;
means for concurrently connecting to the plurality of live auction events by establishing a network connection with the means for connecting in order to request updated data from the means for storing information,
means for receiving a selection of one or more items from a first live auction event and the one or more items from a second auction event as a saved lot grouping;
wherein upon a request for the saved lot grouping, the means for connecting to the means for storing information automatically loads the first and second auction events.
